(19) United States
(12) Patent Application Publication
(10) Pub. No.: US 2016/0356959 A1
(43) Pub. Date: Dec. 8, 2016

(54) Tunable Optical Element

(71) Applicants: Hasitha JAYATILLEKA, Vancouver (CA); Kyle Jacob MURRAY, Vancouver (CA); Lukas CHROSTOWSKI, Vancouver (CA); Sudip SHEKHAR, Vancouver (CA)

(72) Inventors: Hasitha JAYATILLEKA, Vancouver (CA); Kyle Jacob MURRAY, Vancouver (CA); Lukas CHROSTOWSKI, Vancouver (CA); Sudip SHEKHAR, Vancouver (CA)

(73) Assignee: Huawei Technologies Canada Co., Ltd., Kanata (CA)

(21) Appl. No.: 15/013,534

(22) Filed: Feb. 2, 2016

Related U.S. Application Data
(60) Provisional application No. 62/171,907, filed on Jun. 5, 2015.

(51) Int. Cl. G02B 6/293

(52) U.S. Cl. CPC G02B 6/29395; G02B 6/2934; G02B 6/29382

(57) ABSTRACT

The disclosure demonstrates n-doped resistive heaters in silicon waveguides showing photoconductive effects with high responsivities on the order of 100 mA/W. These photoconductive heaters, integrated into microring resonator (MRR)-based filters, can be used to automatically tune and stabilize the filters' resonance wavelength to the input laser-wavelength. This is achieved without requiring dedicated defect implantations, additional material depositions, dedicated photodetectors, or optical power tap-outs. Series-coupled higher-order MRR-based filters can be automatically tuned by sequentially aligning the resonance of each MRR to the laser-wavelength by using photoconductive heaters to monitor the light intensity in each MRR. Embodiments allow for the automatic wavelength stabilization of MRR-based optical circuits.

### CROSS REFERENCE TO RELATED APPLICATIONS

This application claims the benefit of priority to U.S. Patent Application Ser. No. 62/171,907 entitled “WAVELENGTH TUNING AND STABILIZATION OF MICRORING FILTERS” filed Jun. 5, 2015, which is hereby incorporated by reference in its entirety.

### TECHNICAL FIELD

This disclosure relates to tunable optical elements, and in particular to microring resonator (MRR) based optical filters.

### BACKGROUND

Optical switches and tunable optical filters are valuable elements in modern photonic networks. For example, reconfigurable Wavelength Division Multiplexed (WDM) optical networks, including Metro networks, Passive Optical Networks (PON), and high performance computing, make use of different wavelengths for various purposes, including a form of addressing. As such, many optical/photonic networks need devices that allow the selection of a wavelength to be added to or dropped from the transport link. Optical switches and tunable filters are also valuable in instrumentation applications, such as spectroscopy. Accordingly, there is a need for tunable optical elements which can be used as components for such devices.

Microrings fabricated in silicon photonic integrated circuits have been widely researched for various applications, including wavelength tunable filters for optical networks. A microring is a waveguide loop that is typically circular but in principle may be any geometry. The microring is optically coupled to one or two transport waveguides. In a scenario in which the microring is coupled to a single waveguide, it provides the ability to remove a set of wavelengths from the transport waveguide, thus acting as a notch filter. In a scenario in which the microring is coupled to two transport waveguides, the transport waveguides couple light to/from the microring. If light transported by the first waveguide includes wavelengths which are resonant to the ring, then the resonant wavelengths of light can be coupled from the first transport waveguide into the ring, and propagate around the ring to be coupled to the second transport waveguide. Wavelengths of light that are not resonant to the ring are passed from the input of the first transport waveguide to the output of the first transport waveguide, and do not substantially interact with the microring. Filters with desirable bandpass characteristics may be formed by coupling multiple microrings to each other with or without intervening transport waveguides.

Microrings are known to be extremely sensitive to variations in fabrication parameters, such as the thickness and width of the waveguide material. Minor variations in these parameters can result in changes to the wavelength of light that the microring is resonant to. Therefore, to be of practical use, microrings require a mechanism to tune the resonance of the microring to a target wavelength and detect that it is resonant to the target wavelength. Typically, a microring's resonant wavelength can be tuned by controlling the temperature of the microring using a heating element in the vicinity of the microring. In the prior art, drive circuits are employed to drive the heating element of the microring, and a distinct photodetector (PD) (typically on the output waveguides) is connected to a monitor circuit to detect whether the output is bright (indicating coupling had been achieved) or dark. The determination of “bright” vs. “dark” is often a matter of comparing the values to a threshold to determine that there is sufficient coupling of light into the ring. A control circuit then provides feedback control to the drive circuit based on the output of the monitor circuit so as to set and lock the microring to a desired wavelength.

In larger applications, which may employ a large number of microrings, the number of monitor, control and drive circuits must scale with the number of microrings, which can make implementation more complex. The use of separate photodetector and heater elements increases the area required and the number of electrical contacts that must be provided for each microring. Accordingly, it is desirable to reduce the number of electrical contacts and the area (or footprint) of the chip to increase circuit density and improve manufacturing yield.

### SUMMARY

An aspect of the disclosure provides a tunable optical element such as a filter or a switch. The tunable optical element comprises a lightly-doped semiconductor material that is used to heat and thereby tune the filter by means of a controllable drive-current. The semiconductor material is also electrically responsive to light, for example as a photoconductor. This can be arranged in a microring resonator (MRR) such that the photoconductive change is related to the resonance of the incident light within the microring. As the semiconductor material can operate as both a resistive heater and a photoconductor, it can be used for both sensing and controlling the resonant wavelength of the device. Accordingly, such a device can include a feedback circuit comprising an electrical driver and an electrical current measuring element, which identifies the strength of the photoconductive change, which in turn corresponds to the light intensity inside the microring. Such a feedback circuit can vary the drive conditions in response to the measured photoconductive change to automatically control the resonance wavelength of the microring. This allows the device to be configured to either drop a wavelength or to pass through the wavelength, automatically. For example, the feedback circuit can maximize the photoconductive change for a particular wavelength to maximize the strength of the optical coupling for that wavelength from one transport waveguide to another. Accordingly, the device can be configured with a drop port coupled to the ring, and feedback circuit can be configured to drop a signal by maximizing the coupling to the drop port. The feedback circuit can also vary the drive conditions to minimize the photoconductive change and thereby tune the ring to a condition where its interaction with an incident light wavelength is minimized. This minimizes the strength of the optical coupling, thereby minimizing the power transferred from one transport waveguide to another. Accordingly, the feedback circuit can be configured to pass through a signal by minimizing the coupling to the drop port.

Accordingly, an MRR using an in-resonator photoconductive heater can operate as a tunable filter, of which the filter's center wavelength can be automatically tuned/controlled. Several of such MRRs may be further coupled in series where a high-order (or flat-top) filter response is desired and the overall filter response can also be automatically tuned/controlled using the in-resonator photoconductive heaters in each of the MRRs.

Accordingly, an aspect of the disclosure provides for a microring having an electrical heater, said heater also acting as a photodetector that detects the optical power circulating in the microring. As the same element can act as both the heater and photodetector, it only requires two electrical contacts. Thus the same element, and the same pair of contacts, may be used by both the drive circuit and the monitor circuit, which may be combined into a single drive/sense circuit. This saves space on the device and reduces the number of contacts. An aspect of the disclosure also describes the tuning and control of high-order MRR filters. This includes the experimental demonstration of automatic tuning and control of a two-ring filter and the theoretical extension of the invention to tune and control a six-ring filter.

An aspect of the disclosure provides a tunable optical element. The tunable optical element includes a semiconductor material arranged to form a microring resonator (MRR). The tunable optical element further includes an in-resonator photoconductive heater (IRPH) formed by doping at least a portion of the semiconductor material such that the IRPH both heats the MRR in response to an electrical input applied to the IRPH and is electrically responsive to light within the MRR, producing a photocurrent responsive to the light in the MRR.

Another aspect of the disclosure provides a tunable optical element. The tunable optical element includes a semiconductor material arranged to form a microring resonator (MRR). The tunable optical element also includes an in-resonator photoconductive heater (IRPH) comprising at least a portion of the semiconductor material doped at a first doping level such that the IRPH both heats the MRR in response to an electrical input applied to the IRPH and is electrically responsive to light within the MRR, producing a photocurrent responsive to the light in the MRR. In some embodiments, the tunable optical element also includes electrical contacts for providing the electrical input to the IRPH to control the degree of heating, and for supplying the photocurrent to a feedback circuit such that the photocurrent produced by the IRPH can be used by the feedback circuit to control the degree of heating. In some embodiments the semiconductor material further includes inner and outer portions doped at a second doping level, the inner and outer portions configured to provide low-resistance electrical contacts to the IRPH. In some embodiments, the semiconductor material is silicon shaped as a waveguide. In some embodiments, the IRPH comprises an n-doped middle portion of the semiconductor material. In some embodiments, the second doping level comprises n++ doping. In some embodiments, the photocurrent produced by the IRPH is dependent on intensity of the light in the MRR. In some embodiments the electrical input supplied via the electrical contacts adjusts the heating of the IRPH such that the MRR resonates at a desired wavelength. In some embodiments, the MRR is configured to initially resonate at a desired wavelength, and wherein the electrical input supplied via the electrical contacts heats the IRPH to adjust for drifts such that the MRR continues to resonate at the desired wavelength. In some embodiments, the MRR comprises a circular ring, and the tunable optical element further comprises an input waveguide for supplying light at a plurality of wavelengths into the MRR, and a drop waveguide for outputting a desired wavelength, which resonates within the MRR. In some embodiments, the electrical responsiveness to light is due to absorption of light by defects within the semiconductor material induced by doping. In some embodiments the tunable optical element includes a plurality of MRRs, together with corresponding IRPHs, communicatively coupled together.

Another aspect of the disclosure provides a tunable optical element. The tunable optical element includes a semiconductor material configured to act as a waveguide arranged in a loop such that light can circulate in the loop. The tunable optical element also includes a first portion of the semiconductor material lightly doped to be able to both heat the semiconductor material in response to an electrical input applied to the semiconductor material, and produce a photocurrent responsive to the light circulating in the loop. In some embodiments the tunable optical element also includes conductors for conducting the photocurrent, and the semiconductor material includes inner and outer portions more heavily doped to allow the photocurrent to flow through the conductors to a feedback circuit. In some embodiments the conductors comprise electrical contacts to the more heavily doped portions. In some embodiments the electrical contacts comprise same contacts for providing the electrical input to control a degree of heating; and for supplying the photocurrent to the feedback circuit such that the photocurrent produced in the loop can be used by the feedback circuit to control the degree of heating. In some embodiments the loop comprises a circular ring, wherein the photocurrent produced in the ring is dependent on the degree to which the ring resonates at a wavelength of light circulating in the ring. In some embodiments the semiconductor material is configured to form a microring resonator (MRR) having a middle portion with a first doping level and forming an in-resonator photoconductive heater (IRPH). In some embodiments the electrical input supplied to the MRR heats the MRR such that the MRR resonates at a desired wavelength. In some embodiments the MRR is configured to initially resonate at a desired wavelength. In some embodiments, the electrical input controls the degree of heating to adjust for drifts, such that the MRR continues to resonate at the desired wavelength.

Another aspect of the disclosure provides a tunable optical element. The tunable optical element includes a microring resonator (MRR) formed from a semiconductor material. The tunable optical element also includes an integrated in-resonator photoconductive heater (IRPH) formed by doping the semiconductor material and integrated with the MRR. The IRPH acts as both a resistive heater and a photoconductive material. The tunable optical element also includes electrical contacts and a feedback circuit connected through the electrical contacts to a more heavily doped region of the semiconductor material to both control the heating of the IRPH and to measure a photoconductive response of the IRPH in order to tune the MRR. In some embodiments the semiconductor material is silicon shaped as a ring waveguide including an n doped ring region to form the IRPH, and an n++ doped contact region to reduce the electrical resistance of the n++ doped contact region to facilitate flow of electrical current between the ring region and the electrical contacts. In some embodiments the electrical contacts comprise dual-purpose contacts to provide the electrical input to the IRPH to control a degree of heating, and to supply photocurrent produced in the ring region to the feedback circuit such that the photocurrent can be used by the feedback circuit to control the degree of heating of the ring region. In some embodiments the photocurrent produced in the ring region is dependent on a degree to which the ring waveguide resonates with a wavelength of light in the ring waveguide. In some embodiments the feedback circuit tunes the ring waveguide by adjusting the electrical current supplied, such that ring waveguide continues to resonate at a desired wavelength. In some embodiments the ring waveguide is configured to initially resonate at the desired wavelength. In some embodiments the tunable optical element includes a plurality of such MRRs and associated IRPHs communicatively coupled together. In some embodiments the feedback circuit tunes each of the plurality of MRRs in sequence in order to center the filter response at the desired wavelength.

Another aspect of the disclosure provides method for using a doped semiconductor waveguide arranged in a loop such that light can circulate around the loop. The method includes using a pair of electrical contacts to connect the doped semiconductor waveguide to a feedback circuit. The method also includes applying an electrical input via the pair of contacts to heat the doped semiconductor waveguide. The method further includes using the same pair of electrical contacts to measure a photoconductive response of the doped semiconductor waveguide to control the degree of heating.

The foregoing and other objects, features, aspects and advantages of the present invention will become more apparent from the following detailed description, taken in conjunction with the accompanying drawings. It will be understood that the description and the drawings taken in conjunction are intended to provide non-limiting examples to teach the novel aspect of the present invention, and accordingly the drawings and description should not be read in a limiting manner.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1 is a top view illustrating a tunable optical element according to an embodiment.

FIG. 2 is a schematic cross-section of the in-resonator photoconductive heater (IRPH) design according to an embodiment;

FIG. 3 illustrates an add/drop microring resonator (MRR) filter overlaid with a circuit diagram, according to an embodiment;

FIG. 4 is a flowchart of a control algorithm according to an embodiment;

FIG. 5 illustrates a series-coupled 2^{nd}-order (two-ring) add/drop MRR filter overlaid with a circuit diagram according to an embodiment;

FIG. 6 is a flow chart illustrating the steps of the control algorithm executed by a sensing and monitoring circuit according to an embodiment used to stabilize a 2^{nd}-order series-coupled MRR;

FIG. 7 illustrates a 6^{th}-order (six-ring) series-coupled add/drop MRR filter;

FIG. 8 illustrates the simulated through- and drop-port transmission spectra of the 6^{th}-order filter of FIG. 7 before and after tuning;

FIGS. 9A-F illustrate the calculated optical cavity intensity in MRRs 1-6 of the 6^{th}-order filter of FIG. 7 as each of the MRRs are sequentially tuned according to an embodiment of a tuning algorithm;

FIG. 10 is a schematic of the experimental setup used to demonstrate wavelength stabilization of the add/drop filter shown in FIG. 3 according to an embodiment;

FIG. 11A is a plot of measured Iₕₑₐₜₑᵣ versus Vₕₑₐₜₑᵣ for an in-resonator photoconductive heater (IRPH) of an MRR filter;

FIG. 11B shows the measured drop-port optical transmission and I_{PD} as a function of the wavelength of the optical input;

FIGS. 12A and 12B show the measured responsivities of the IRPH as a function of Pᵢₙₚᵤₜ and Vₕₑₐₜₑᵣ respectively;

FIG. 13A shows I_{PD} and Vₕₑₐₜₑᵣ measured as functions of time;

FIG. 13B illustrates the normalized drop-port transmission measured as a function of time during the progression of the control algorithm;

FIG. 13C shows the normalized through- and drop-port transmission spectra of the MRR filter before and after the control algorithm was applied wherein the output wavelength of the TLS was 1552 nm;

FIG. 14A is a measured eye diagram at constant stage temperature;

FIG. 14B illustrates measured stage temperature as a function of time;

FIG. 14C is a measured eye diagram when automated wavelength stabilization is applied;

FIG. 14D is a measured eye diagram without automated wavelength stabilization;

FIG. 15A illustrates the measured I_{PD1} as a function of Vₕₑₐₜₑᵣ₁;

FIG. 15B illustrates the measured I_{PD1} (right axis and top curve) and I_{PD2} (left axis and bottom curve) as a function of Vₕₑₐₜₑᵣ₂;

FIG. 15C illustrates the measured through-port and drop-port responses of the second-order series-coupled MRR filter before and after tuning the filter to a wavelength of 1554 nm;

FIG. 16A illustrates a calculated normalized cavity intensity in MRR 2 according to an embodiment;

FIG. 16B illustrates the through-port and drop-port transmission spectra before and after applying the control algorithm to the initially tuned spectrum in FIG. 15C, wherein the wavelength is relative to 1554 nm;

FIG. 17A is a measured eye diagram at constant stage temperature;

FIG. 17B illustrates the measured stage temperature as a function of time;

FIG. 17C is a measured eye diagram with automated wavelength stabilization;

FIG. 17D is a measured eye diagram without automated wavelength stabilization.

### DESCRIPTION OF EMBODIMENTS

Silicon photonic microring resonator (MRR)-based filters, modulators, and switches have been investigated for use in optical networking, data-centers and high performance computing systems due to their high-speed operation, low power consumption, and compact device footprints. Many of the benefits exhibited by MRR-based devices are due to their resonant spectral responses, which also makes their performance highly susceptible to variations in fabrication and to fluctuations in both chip temperature and laser wavelength. In order to overcome these issues, for practical deployment of MRR-based technologies, development of scalable, low-cost, and energy efficient techniques for wavelength tuning and stabilization of MRR-based devices would be beneficial.

Automatic wavelength tuning and stabilization of MRR-based devices is typically achieved using feedback loops, which require both sensing and controlling of the resonance conditions of the MRRs. The sensing operation can be performed using on-chip temperature sensors or, alternatively, using photodetectors (PDs) to monitor the light intensity at the output ports or inside the MRRs. Solutions with on-chip PDs that require light to be tapped out from the MRRs, or their outputs, do not scale well towards densely integrated systems due to the increase in device footprint and insertion losses. Sensing mechanisms based on monitoring the light intensity in the MRRs, with in-resonator PDs, are more scalable. For example, in-resonator PDs can be fabricated using defect state absorption (DSA). DSA is the process of electron-hole pair generation by sub-bandgap defect energy levels, formed primarily as a result of ion implantation. Prior art designs have required dedicated ion implantation steps to create sufficient defect states for significant absorption, increasing the cost and complexity of fabrication.

The control operation can be performed using thermo-optic (TO) or electro-optic (EO) phase shifters to tune the resonance wavelength of the MRR. EO and TO phase shifters are also referred to as tuners. The TO phase shifters are typically implemented using metallic or doped silicon resistive heating elements and have been proposed for MRR tuning. Resistive heating elements take advantage of the large TO coefficient of silicon. For wavelength stabilization, heating elements are typically used together with dedicated PDs inside or outside of an MRR. Recently, germanium-based in-resonator photoresistive heaters have been demonstrated for both sense and control operations, thereby avoiding the need for dedicated PDs. However, germanium-based devices require the deposition of germanium, which increases fabrication complexity.

Aspects of this disclosure are directed to automated wavelength tuning and stabilization of MRR filters using in-resonator photoconductive heaters (IRPHs). According to the example embodiments discussed herein, the IRPHs are formed by using n-type doping in a waveguide section. The n-type doping allows the IRPHs to be used as resistive heaters. However, the inventors herein have also determined that the doping process used to make the IRPH also makes the IRPH/MRR behave as a photoconductive material, which, under appropriate conditions, can produce a photocurrent responsive to the light in the MRR. In other words, an appropriate doping can achieve DSA, without the dedicated ion implantation steps. Accordingly, embodiments discussed herein include n-doped heaters that are built into the MRRs, i.e., IRPHs, which are used for both the sensing and the control operations, without requiring a photodetector. As a result, automated stabilization of the MRRs can be achieved without requiring any of dedicated ion implantation steps, germanium depositions, and dedicated on-chip PDs. Furthermore, the use of IRPHs allows for a simple and scalable method for tuning higher-order series coupled MRR filters because the tuned-state can be determined by measuring the current output from the MRR's IRPH.

Embodiments will be discussed using circular MRRs, although it should be appreciated that an MRR can have other geometries which include a waveguide arranged in a loop such that light can circulate around the loop.

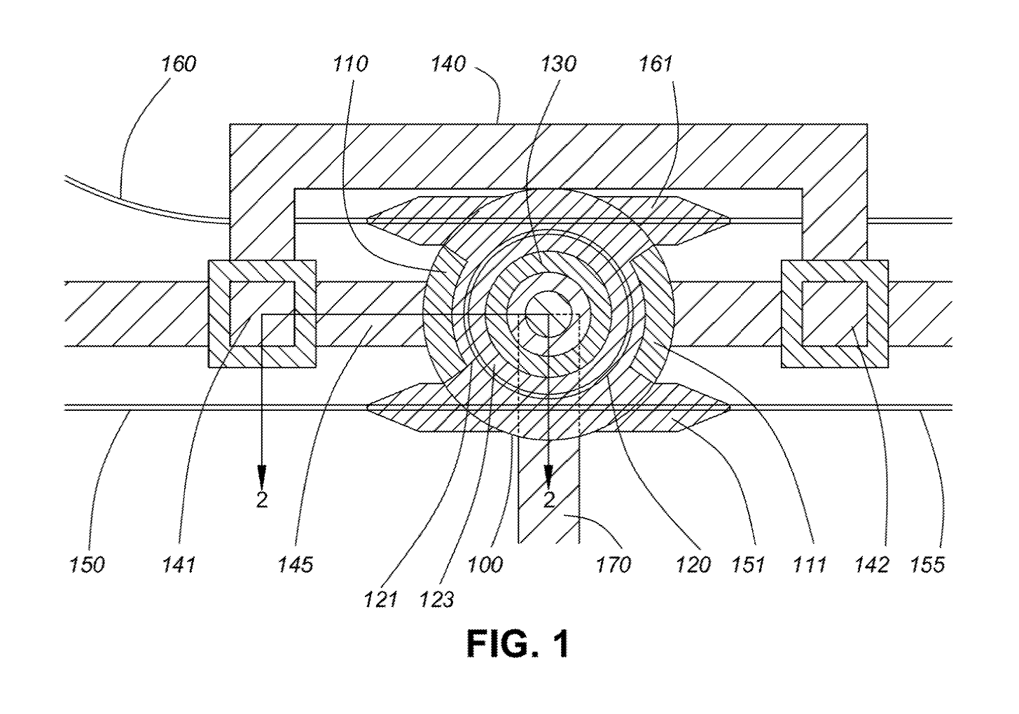

FIG. 1 is a top view illustrating a tunable optical element according to an embodiment. FIG. 1 includes a circular MRR 100 which is lightly doped to form an IRPH. The ring includes an outer portion (which includes portions 110, 111), middle portion (120, 121, 123) and an inner portion 130. The middle portion (120, 121, 123) forms the ring resonator waveguide and the IRPH. The same semiconductor material forms coupling region 161, which couples the ring to drop waveguide 160. Similarly, coupling region 151 couples the input waveguide 150 and through (also called a “bus”) waveguide 155 to the ring. It should be noted that input waveguide 150 and through waveguide 155 can be considered a single waveguide which carries an input signal before the ring and a through signal after the ring. Metal contacts at 141 and 142 connect to metal strip 140 and metal strip 145. Metal Strip 170 forms part of a feedback circuit, which is explained in more detail below, is illustrated partially in phantom so as to not obscure what lies beneath.

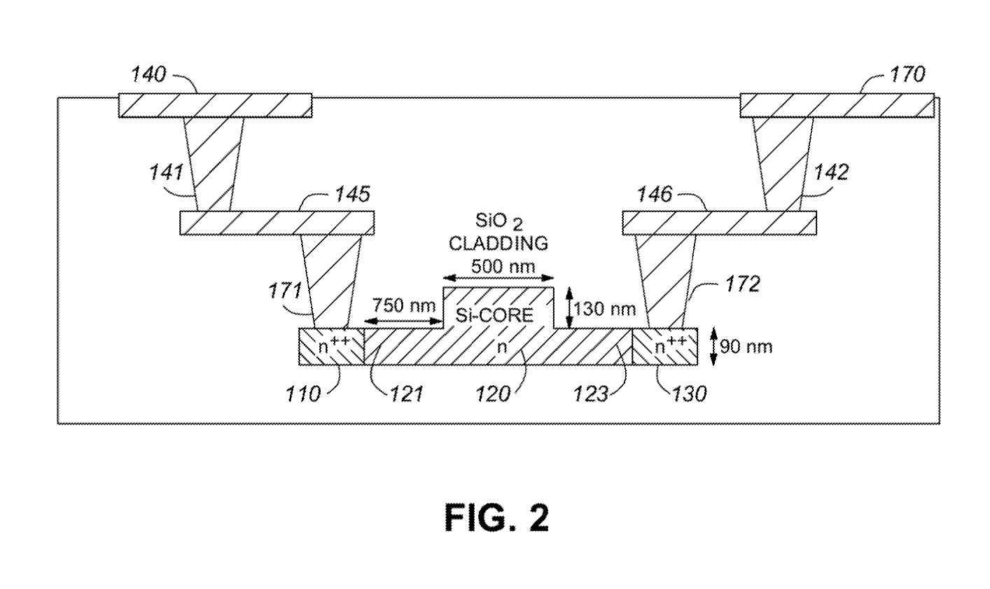

FIG. 2 is side view along cross section line 2-2 of FIG. 1. FIG. 2 shows that the MRR is formed from a semiconductor material in which the middle portion 120, 121 and 123 doped at a first doping level. In some embodiments, the middle portion is lightly doped, for example using n-type doping (hereafter referred to as n doped). In some embodiments, the semiconductor material comprises silicon (Si).

The Si acts as a core of a waveguide, and the n doping makes the ring act as an IRPH. The Si core can be disposed within a SiO₂ cladding as shown, although it should be noted that the size of the cladding can vary. The middle part 120 of the middle portion of the MRR is thicker than parts 121 and 123 to contain the light within the waveguide. Outer portions 110, 111 and inner portion 130 are doped using a second doping level. In some embodiments, they are more heavily doped, for example n++ doped. The heavier doping reduces the contact resistance of the semiconductor material to the metal contacts. Outer portion 110 is connected to metal contact via 171 which connects with metal strip 145 of FIG. 1. Inner portion 130 is connected to metal contact via 172. Inner portion 130 and outer portion 110 are n++ doped to provide low-resistance portions which allow current to flow through electrical contacts 171 and 172. Accordingly, current can flow between metal strip 140 and outer ring portion 110 through metal strip 145 and vias 141 and 171. Further, current can flow between inner ring portion 130 and metal strip 170 through strip 146 and vias 142 and 172.

Metal strips 140 and 170 allow current to flow between the ring and a feedback circuit for controlling the heating of the IRPH, and for measuring a photocurrent (sensing signal) produced by the ring in response to the light which flows through it. This allows for the same electrical contacts to be used to provide the electrical current for the control signal and for supplying the photocurrent to the feedback circuit. For example, such an arrangement allows the two contacts 171 and 172 to be used for both the heating control signal and the sensing signal, reducing the complexity of the device compared to a device in which each signal need its own contacts into the ring. The dimensions of this illustrated embodiment are indicated in the figure. It should be appreciated that these dimensions are just an example and that dimensions can vary depending on such factors as the desired wavelength to which the MRR is configured to resonate, the degree of loss which can be tolerated by the application, etc.

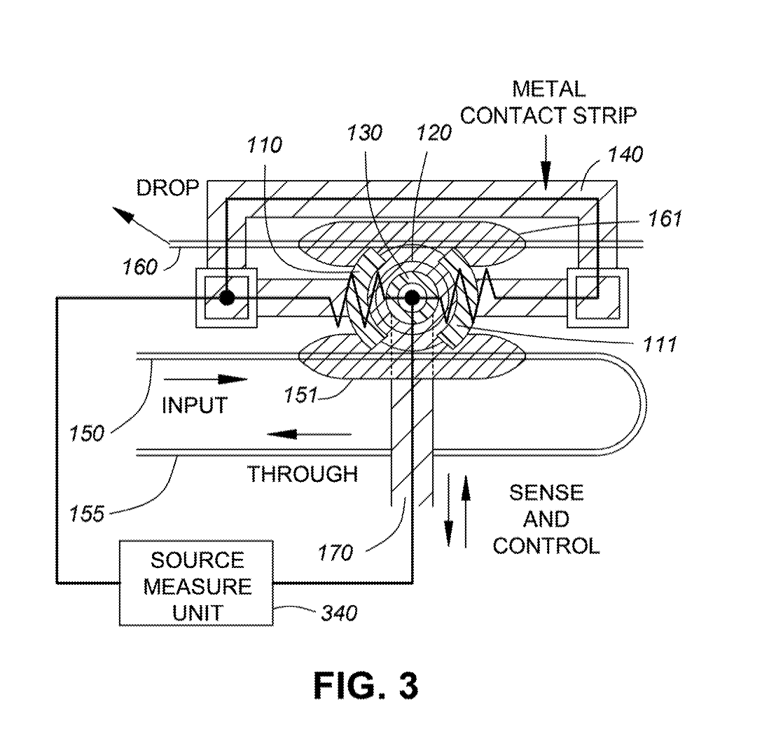

FIG. 3 is a schematic representation of a first-order add/drop MRR filter including an integrated IRPH with an electrical circuit diagram superimposed thereupon, according to an embodiment. The optical input and output ports of the device are labeled as “input”, “drop” and “through”. Light from the input-port is coupled to the MRR device via coupling region 151. The light then travels around the MRR. When the MRR is at resonance with the input wavelength, the output signal at the drop-port is maximized. The output signal at the through-port is minimized due to destructive interference. When the MRR is not resonant with the wavelength of the input light the light exits from the through-port. FIG. 3 also shows a feedback circuit used to tune and/or stabilize the MRR, including a control unit, labelled as source measure unit 340 with its associated Sense and Control signals. The resonance wavelength of the MRR filter can be tuned by applying a voltage, Vₕₑₐₜₑᵣ, across the IRPH. It should be noted that applying a Vₕₑₐₜₑᵣ is equivalent to supplying a “heating” current to heat the IRPH, either of which can be a control signal referred to as an electrical input. Accordingly while Vₕₑₐₜₑᵣ as an applied voltage does not have a direction and is expressed with respect to ground, the figure schematically illustrates a double arrow representing a control input to the device and the current flowing out of the device as sensing signal. The current flowing through the device, and output as the sensing signal which can be measured, includes two parts: (1) the dark current, Iₕₑₐₜₑᵣ, which is the current that flows through the IRPH due to the applied voltage, Vₕₑₐₜₑᵣ, and (2) the photocurrent, I_{PD}, which is the current generated due to DSA. I_{DP} depends on both the light intensity inside the MRR and on the applied Vₕₑₐₜₑᵣ. In other words the Iₕₑₐₜₑᵣ is the current that flows in response to the applied voltage, Vₕₑₐₜₑᵣ and is present regardless of whether the ring is on resonance or not. The sensing signal output will also include a photocurrent I_{DP}, which will change significantly depending whether the ring is on resonance or not. As will be discussed in more detail below with reference to experimental results, the photocurrent I_{DP} generated in the IRPH is maximized when the MRR is on resonance. Note that the schematic resistors illustrated in FIG. 3 are included to symbolize the resistive heating of the IRPH. As can be seen in FIG. 2, in this embodiment metal strip 170 is disposed above the MRR, but like in FIG. 1, is illustrated partially in phantom in FIG. 3 so as to not obscure what lies beneath.

A control algorithm implemented by the source measure unit 340 for the feedback circuit will now be discussed, according to an embodiment. As discussed above, while an MRR is typically configured to resonate at a desired wavelength, an MRR's performance is susceptible to variations in fabrication and tends to drift with fluctuations in both chip temperature and laser-wavelength. Accordingly, the feedback circuit tunes the MRR so it resonates at the desired wavelength.

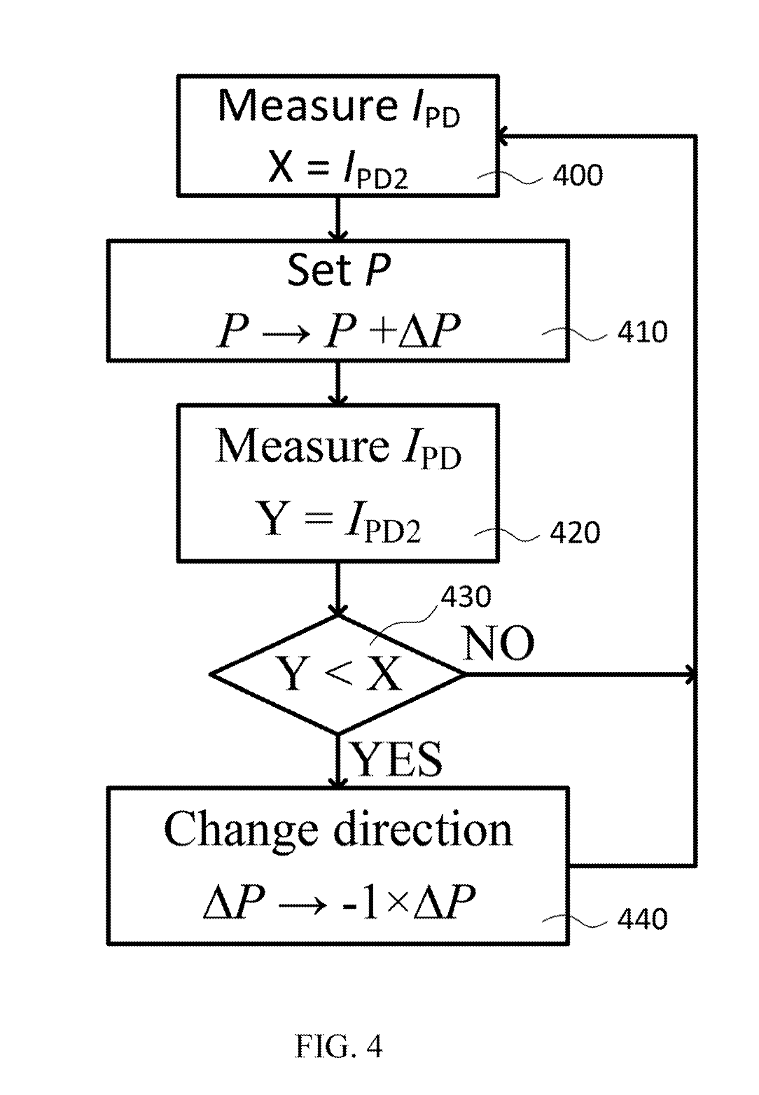

FIG. 4 is a flowchart in which wavelength stabilization is achieved using a computer implemented control algorithm, according to an embodiment. The algorithm continuously searches for the value of Vₕₑₐₜₑᵣ that maximizes I_{PD}. In one embodiment, this is globally maximized. The flow diagram of a control algorithm according to an embodiment is outlined FIG. 4, in which P is the electrical power supplied to the heater. I_{PD} is measured in steps 400 and 420, changing P in a step 410. In each iteration of the algorithm, Vₕₑₐₜₑᵣ is changed in the step 410 such that P is changed by ΔP. If I_{PD} increases (step 430), then ΔP is unchanged and the algorithm proceeds to the next iteration. Otherwise, the sign of ΔP is reversed in a step 440 before proceeding. A one-time calibration step is performed prior to starting the control algorithm to measure Iₕₑₐₜₑᵣ as a function of Vₕₑₐₜₑᵣ so that I_{PD} can be calculated. Accordingly, the photocurrent produced by the ring is measured to determine the degree of heating to be applied to ensure the ring remains tuned to the desired wavelength. The feedback circuit can be controlled by a microcontroller, an integrated complementary metal-oxide semiconductor (CMOS) electronic circuit, or the like.

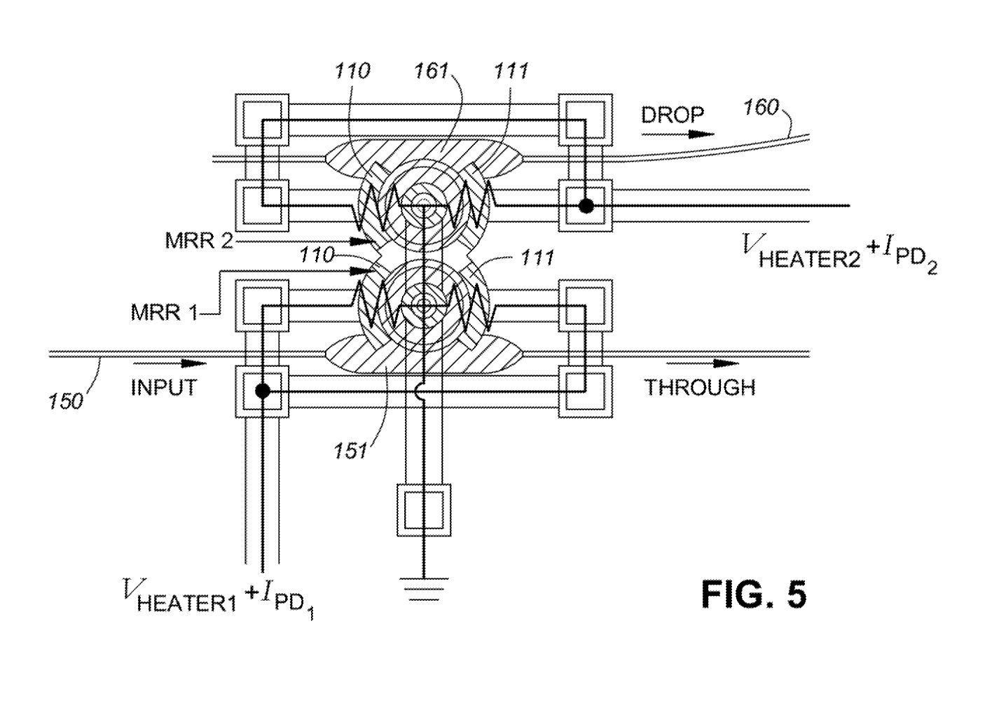

As stated, FIGS. 1-3 illustrate a first order (or single-ring) MRR. Compared to first-order filters, embodiments with higher-order (or multiple-ring) MRR-based filters can offer superior spectral characteristics such as a flat-top response and a high out-of-band signal rejection. Accordingly, in some embodiments, multiple rings can be coupled together to improve performance. Automated wavelength tuning and stabilization of a series-coupled 2^{nd}-order add/drop MRR filter according to an embodiment will now be discussed. FIG. 5 is a schematic representation of a 2^{nd} order add/drop MRR filter including integrated IRPHs, with an electrical circuit diagram superimposed thereupon, according to an embodiment. This device has two MRRs coupled to each other (MRR1 and MRR2). Each MRR includes an integrated IRPH formed from n-doping the silicon of the ring. The optical input and output ports of the device are labeled as “input”, “drop” and “through”, and the two rings share the input coupling region 151 and the drop port coupling region 161, similar to those of the device shown in FIGS. 1-3. It should be appreciated the device can be connected to a feedback circuit including a source measure unit (not shown). However signal paths for Vₕₑₐₜₑᵣ₁ and Vₕₑₐₜₑᵣ₂ signals as inputs and currents I_{PD1} and I_{PD2} as outputs are shown. MRRs 1 and 2 can be independently tuned by applying voltages Vₕₑₐₜₑᵣ₁ an Vₕₑₐₜₑᵣ₂ respectively to the IRPHs.

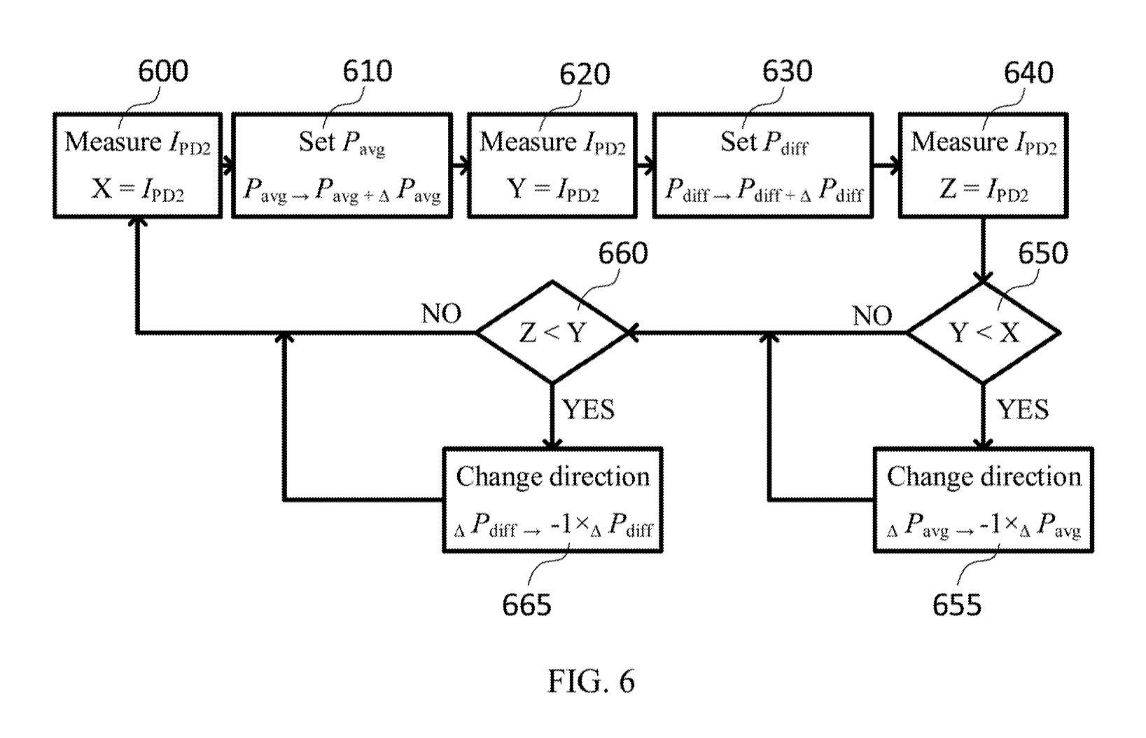

FIG. 6 is a flowchart of a control algorithm implemented by a feedback circuit according to an embodiment, where both MRR1 and MRR2 can be tuned by searching for the maximum I_{PD2}. In each iteration of the algorithm, I_{PD2} is measured in a step 600, and P_{avg} is changed in a step 610 by ΔP_{avg}. P_{avg} is the average power supplied to the heaters,

$${P}_{avg} = \frac{( {P}_{1} + {P}_{2} )}{2} ,$$

and is incremented by a step size of ±ΔP_{avg} (wherein P₁=Vₕₑₐₜₑᵣ₁×Iₕₑₐₜₑᵣ₁ and P₂=Vₕₑₐₜₑᵣ₂×Iₕₑₐₜₑᵣ₂ are the electrical powers supplied to the IRPHs of MRR1 and MRR2, respectively). I_{PD2} is measured again in a step 620, and P_{diff} is changed in a step 630 by ΔP_{diff}, wherein P_{diff} is the difference in power supplied to the heaters,

$${P}_{diff} = \frac{( {P}_{1} - {P}_{2} )}{2} ,$$

which is varied by a step size of ±ΔP_{diff}. I_{PD2} is measured again in a step 640. The sign of ΔP_{avg} is switched in a step 655 if I_{PD2} decreases after the power is changed in a step 650. Similarly the sign of ΔP_{diff} is switched in a step 665 if I_{PD2} decreases after the power is changed in a step 660.

In some embodiments, the rings MRR1 and MRR2 may need an initial tuning step prior to implementation of the control algorithm. An example of such an initial tuning algorithm will be discussed below.

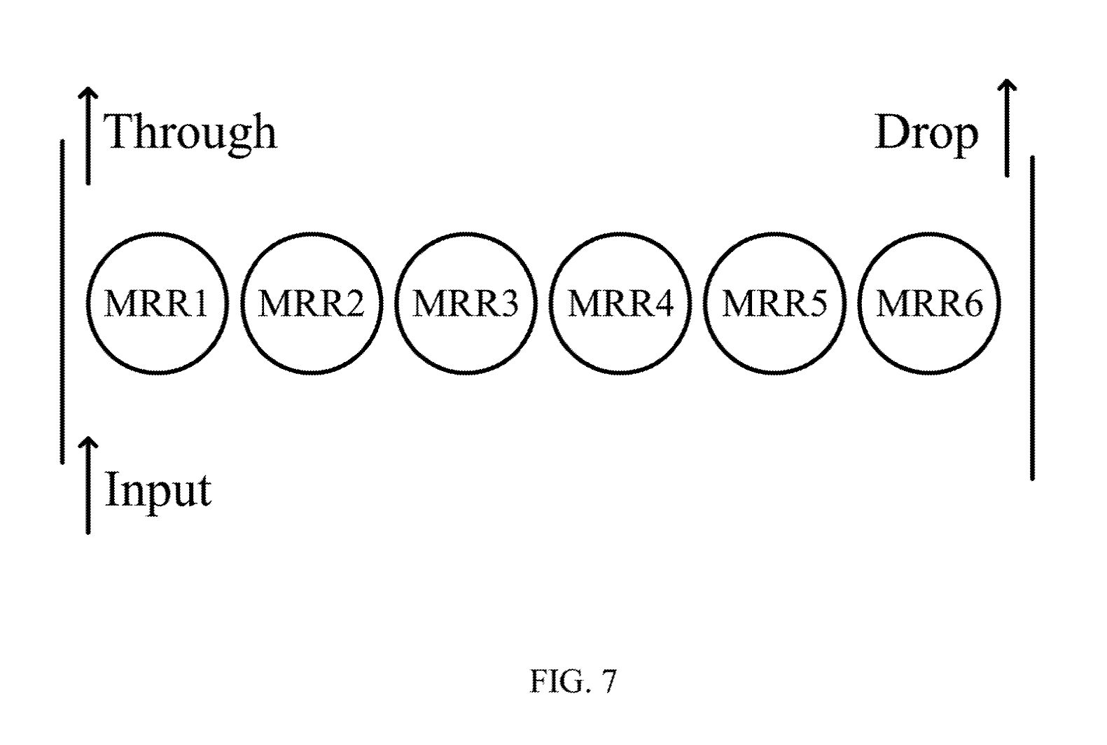

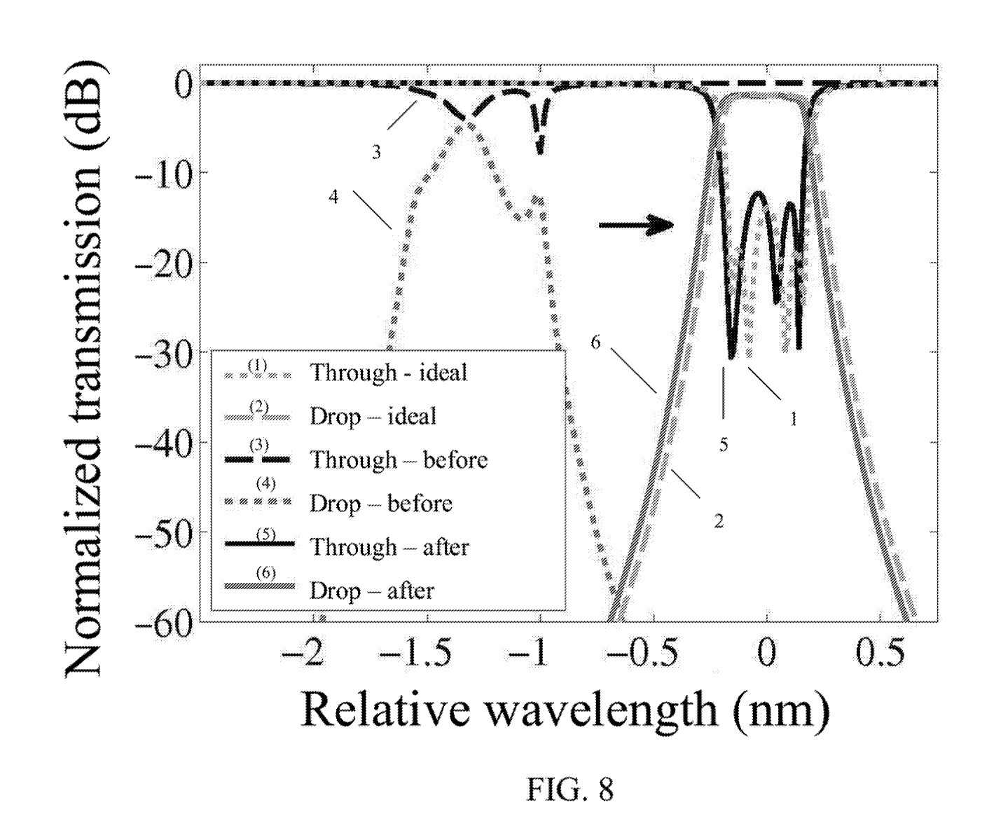

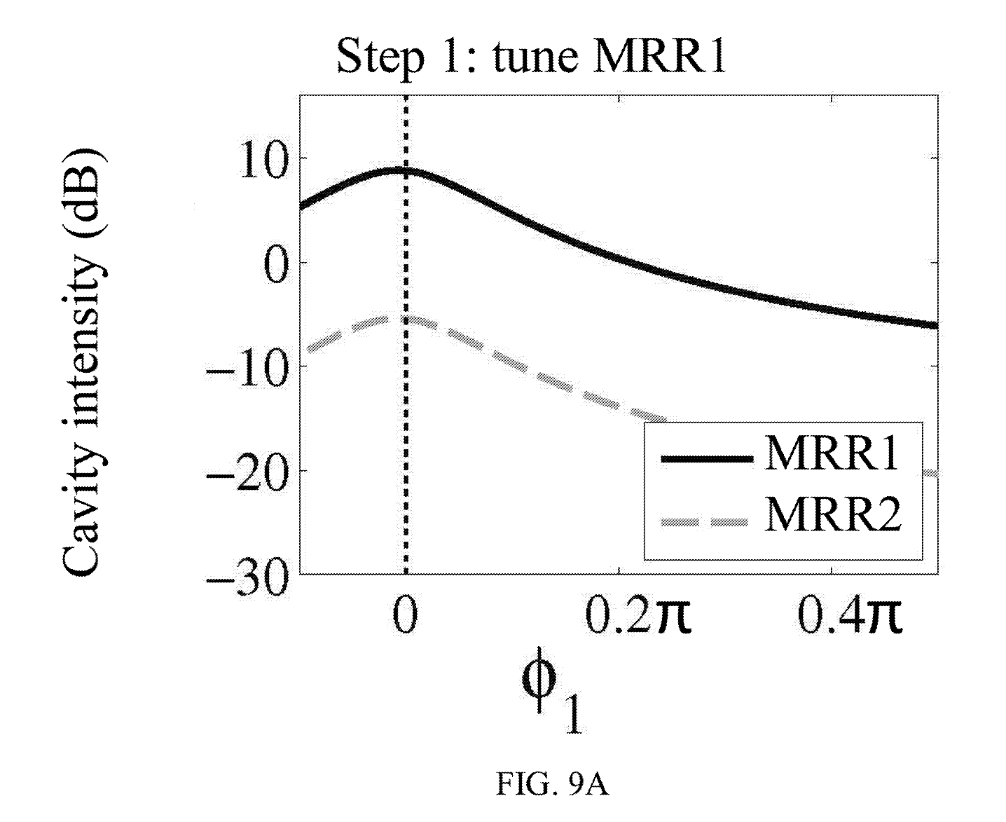

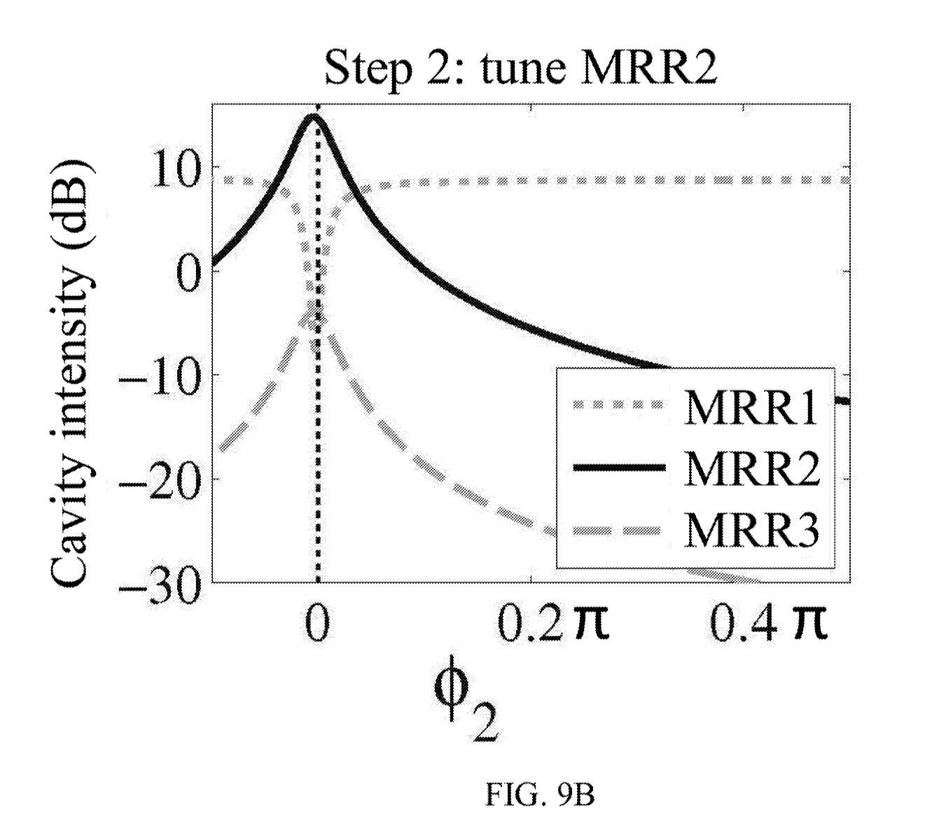

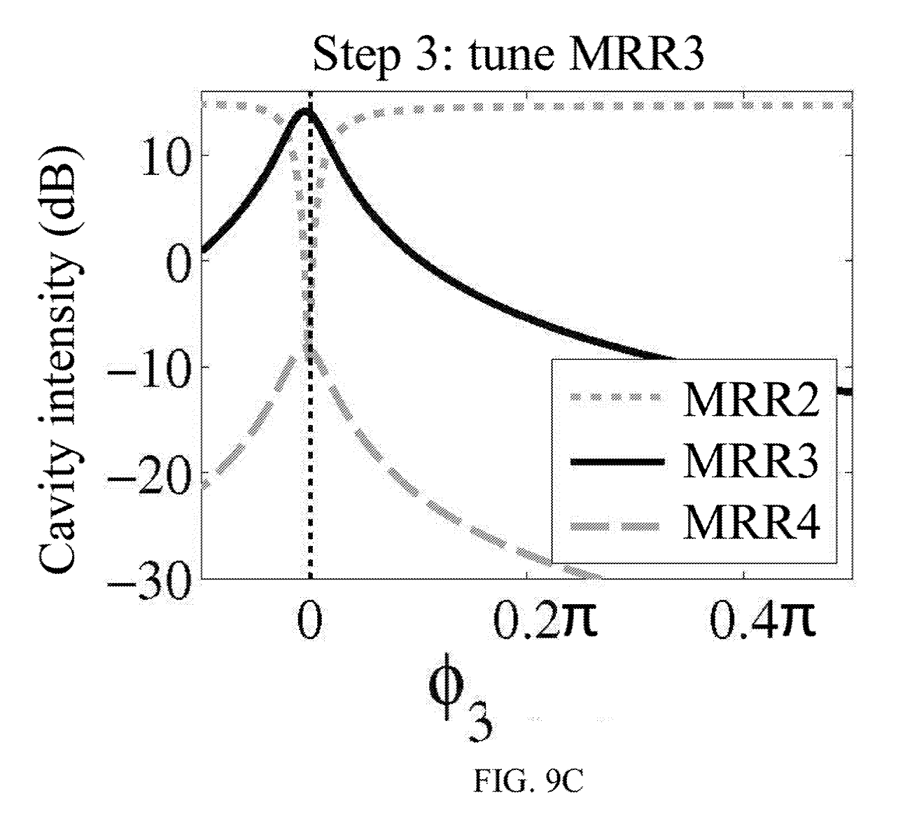

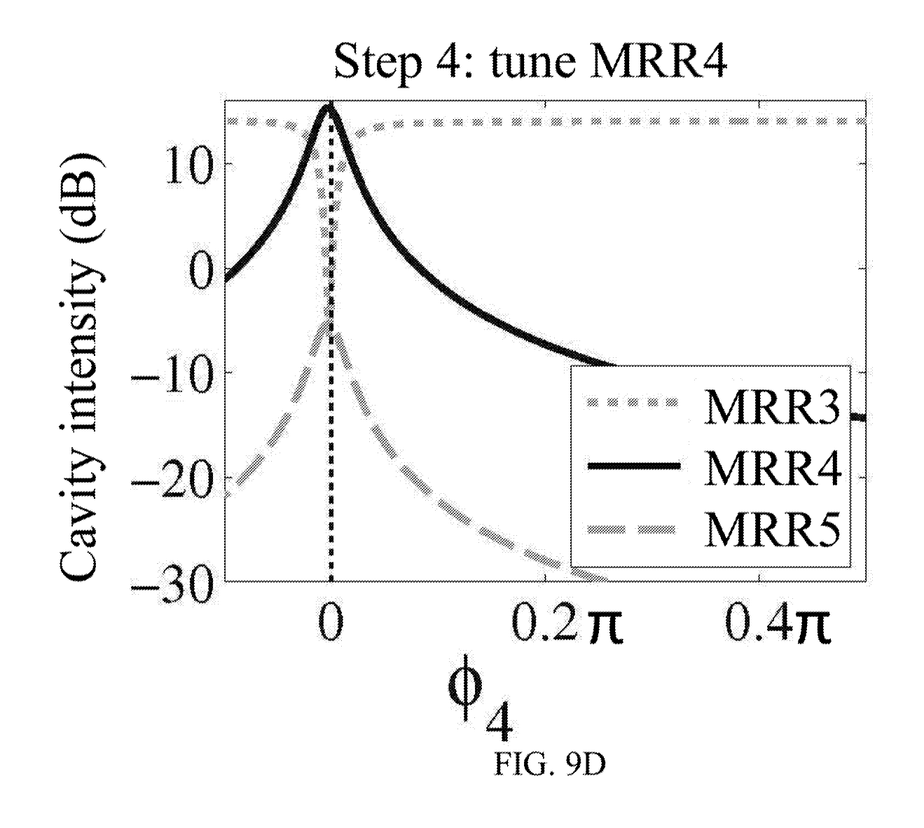

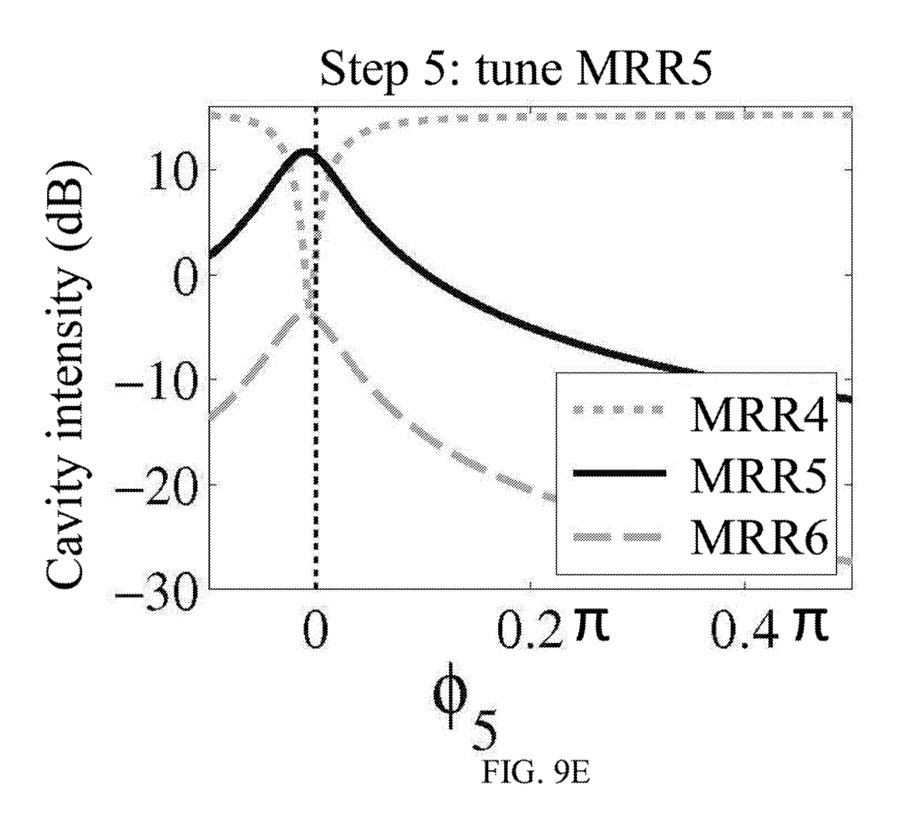

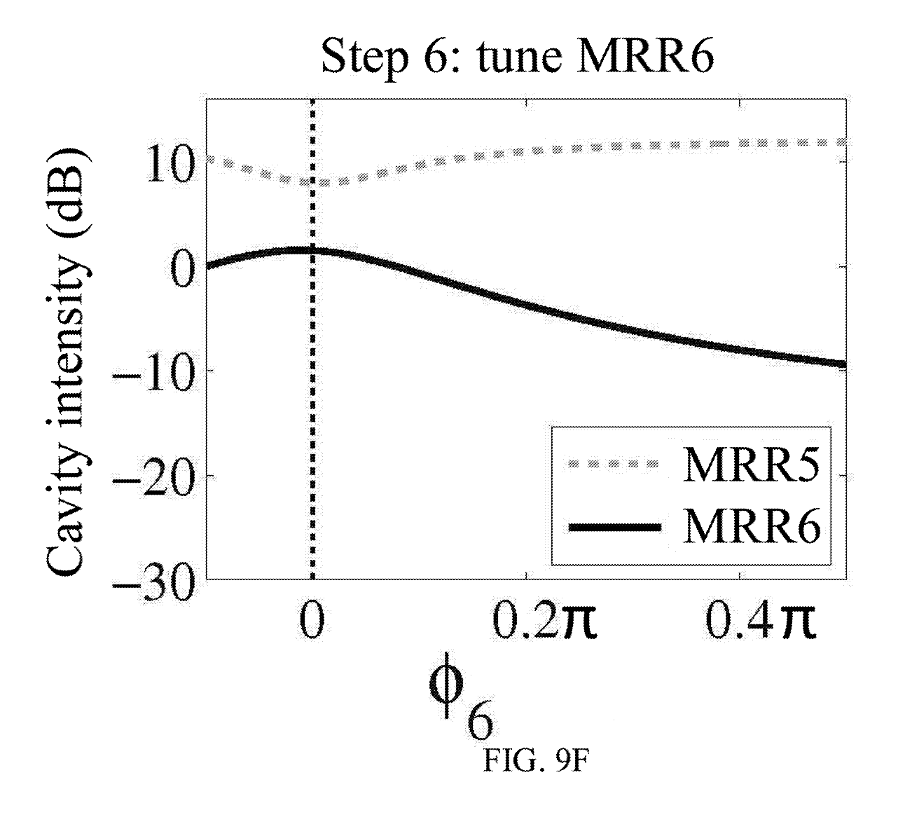

FIG. 7 illustrates a series-coupled sixth order filter including six MRRs (MRR1 . . . MRR6) sharing common input, through and drop waveguides. For the desired filter response to be centered at λ₀, each of the individual MRRs MRR1 to MRR6 should have the same resonance wavelength (λ₀). However, fabrication and temperature variations cause the resonance wavelength of each of the MRRs MRR1 to MRR6 to be detuned from λ₀. Hence, the filter response of the fabricated devices without tuning is often different from the desired response. Therefore, individual tuning of each MRR is utilized in some embodiments to obtain the desired filter response. IRPHs can be used to automatically tune each MRR in a series-coupled N^{th}-order MRR filter to obtain a flat-top response at λ₀. This can be achieved by sequentially tuning the resonance wavelength of each MRR to λ₀, where the resonance condition is found by maximizing I_{PDn}, the photocurrent generated by the IRPH of the n^{th} MRR. An embodiment of an initial tuning algorithm for a configuration of an Nth order MRR is now discussed with reference to FIGS. 8 and 9A-F. The 6^{th}-order series-coupled add/drop MRR filter MRR1 to MRR6 shown in FIG. 7 is used as an example. For a maximally flat pass-band response, the power cross-coupling coefficients for each of the couplers from the input-port to the drop-port were chosen to be:

|κ|²[0.4,0.0146,0.0039,0.0029,0.0039,0.0146,0.4].

For each of the MRRs, the radius is assumed to be 8 μm, the effective index of the waveguides are n_{eff}=2.57, and the waveguide loss is 6 dB/cm. FIG. 8 shows calculated filter responses before and after tuning. The wavelength is shown relative to λ₀=1554.2 nm. The response of the filter was simulated using the transfer matrix method described in J. Poon, J. Scheuer, S. Mookherjea, G. Paloczi, Y. Huang, and A. Yariv, “Matrix analysis of microring coupled-resonator optical waveguides,” Opt. Express 12, 90-103 (2004). In order to simulate the effects of fabrication variations, the round-trip phase for the n^{th} MRR in the filter, φₙ, was calculated using

φₙ=φ_{0,n}+φ_{th,n} (1)

where 100_{0,n} is the initial phase at λ₀, which was modeled using a normal distribution with a mean of −π/5 and a standard deviation of 0.0713π. The embodiment of the tuning algorithm described herein is not sensitive to the values of these parameters, as long as the rings are all initially sufficiently detuned from λ₀. φ_{th,n} is the phase associated with the thermal tuning. The ideal filter response, shown in FIG. 8 as curve 1 for an ideal through port simulation, and as curve 2 for an ideal drop port simulation, corresponds to the case in which each φₙ=2mπ, where m is an integer. Therefore, embodiments of such a tuning method adjust each φ_{th,n} such that an ideal filter response is achieved. FIG. 8 also illustrates curve 3 as a through port simulation before tuning, curve 4 as a drop port simulation before tuning, curve 5 as through port simulation after tuning, and curve 6 as a drop port simulation after tuning.

In order to tune the filter, MRRs MRR1-MRR6 are tuned sequentially to be resonant at λ₀. Tuning of MRR 1 is shown in FIG. 9A, which shows the optical intensity in MRRs MRR1 and MRR2 as φ₁ is tuned. The value of φ₁ corresponding to the maximum optical intensity in MRR1, φ_{1,max}, is recorded. The remaining MRRs are then tuned as follows: in the n^{th} step of the tuning process, the phases φᵢ, i<n, are set to φ_{i,max} and the phase φₙ is swept. φ_{n,max} is then recorded as the phase that maximizes the intensity in MRRn. This process is performed until all rings have been tuned. For each step of the tuning process, the optical cavity intensity corresponding to the MRR that is being tuned, along with the optical cavity intensities of the adjacent MRRs, are shown in FIGS. 9A-F. As shown in FIG. 8, the filter spectra (i.e., curves 5 and 6), after tuning, closely aligns with the simulated ideal responses (curves 1 and 2 respectively). In practice, the phases can be tuned by changing the power supplied to the heater in each MRR MRR1 to MRR6, and the intensity in each ring can be determined by measuring the photocurrent from the MRR's (MRR1 to MRR6)'s MPH. This method of tuning can be generalized to series coupled microring filters with any number of microrings.

As shown in FIGS. 9A-F, the maximum optical cavity intensity in the n^{th} MRR during tuning step n does not occur exactly at φₙ=0 due to the influence of the resonances of the other MRRs. The accuracy of the algorithm can be improved as the initial detuning of the resonators is increased. In an example of the process, the mean initial detuning of −π/5 was chosen to demonstrate that excellent agreement with the ideal filter spectrum can be obtained, even for a small initial detuning.

Experimental results using example devices will now be discussed. The example devices discussed herein were fabricated using 248 nm optical lithography. The experimental devices discussed herein achieved doped silicon IRPH-based automatic tuning and stabilization of first and second-order MRR-based filters.

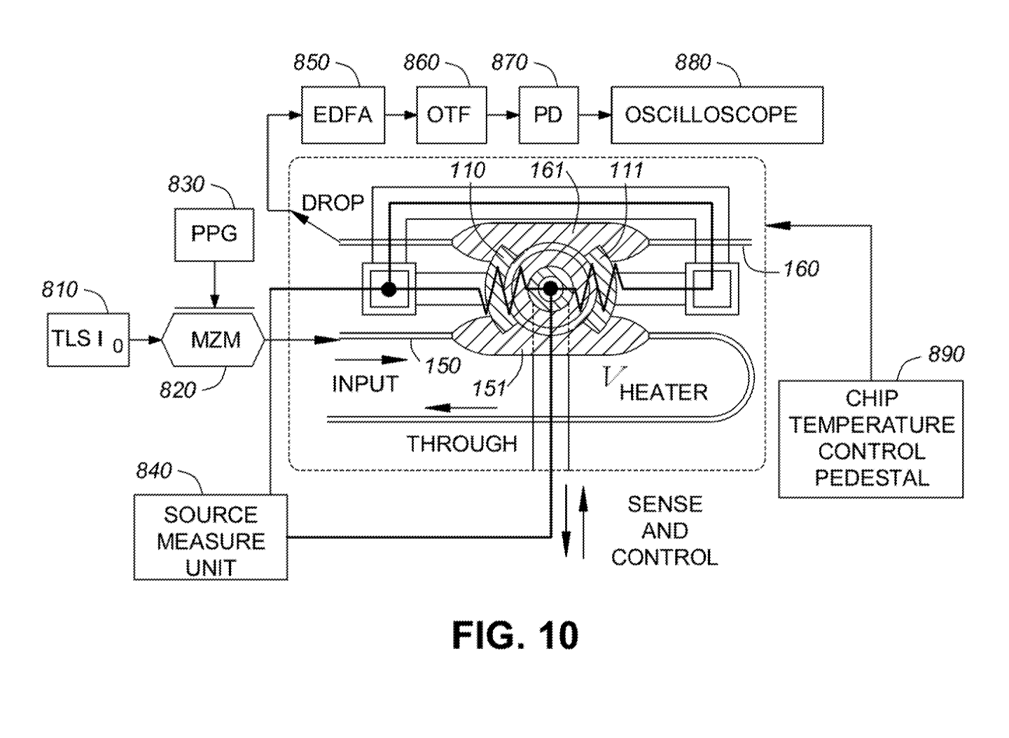

A schematic of the experimental setup used to demonstrate wavelength stabilization according to an embodiment is shown in FIG. 10. FIG. 10 is similar to FIG. 3, but includes additional components that are used to create a test signal and to measure the physical output at the drop port. FIG. 10 also shows the feedback circuit used to tune and/or stabilize the MRR, including a source measure unit 840 with its associated Sense and Control signals. The experimental optical data stream was generated by modulating the output of a tunable laser source (TLS) 810 source using a LiNbO₃ Mach-Zehnder modulator (MZM) 820. The MZM was modulated using a pulse pattern generator (PPG) 830 outputting a non-return-to-zero 2³¹−1 pseudo random binary sequence (PRBS) at 12.5 Gb/s. Grating couplers were used to couple light into and out of the chip. The output from the drop-port of the MRR filter was amplified using an erbium-doped fiber amplifier (EDFA) 850 and was filtered using an optical tunable filter (OTF) 860. The OTF 860 output was connected to a PD 870, which was connected to a real-time oscilloscope 880 (33 GHz, 80 Gs/s) for monitoring eye diagrams. The chip was mounted on a temperature controlled pedestal 890, which used a thermoelectric cooler (TEC) and thermistor combination to monitor and control the chip temperature. The sensing and control operations on the IRPH were performed using the source measure unit 840 with a 1 μA current measurement resolution when used in constant voltage mode. It should be noted that unlike prior art devices which utilize a photodetector (PD) as the sensing input to the feedback circuit, the PD 870 in this experimental setup is not needed for tuning the MRR, but instead to verify the results and produce the eye diagrams.

The source measure unit 840, illustrated in FIG. 10, is part of the feedback circuit and may be a circuit element hardwired to carry out this procedure or could include a processor executing software instructions for carrying out the procedure. It should be noted that source measure unit 840 can control a plurality of MRRs.

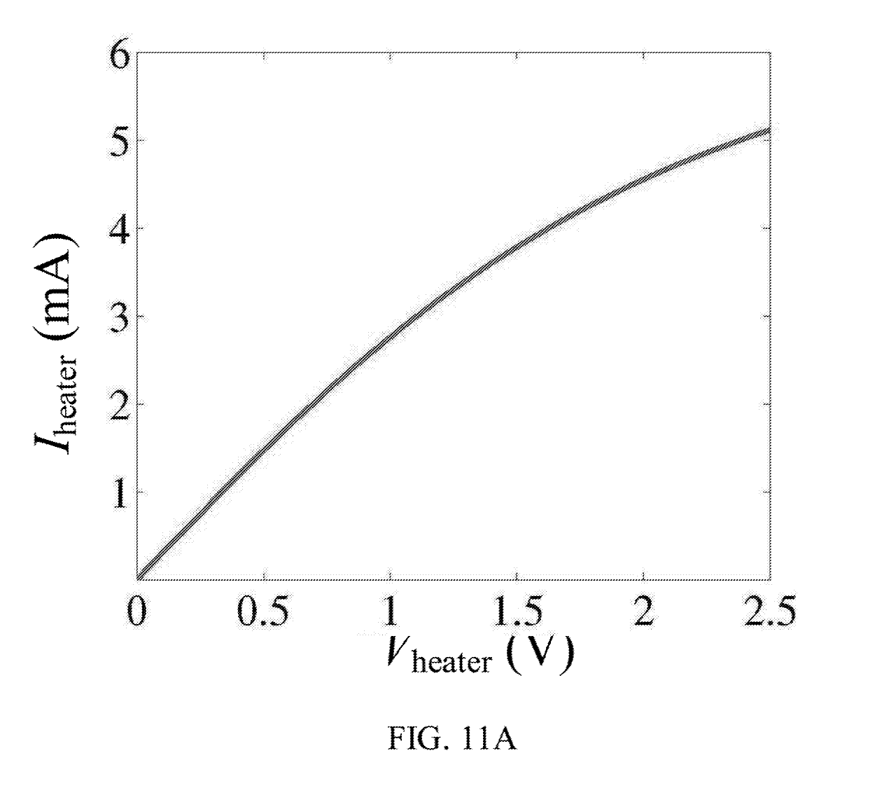

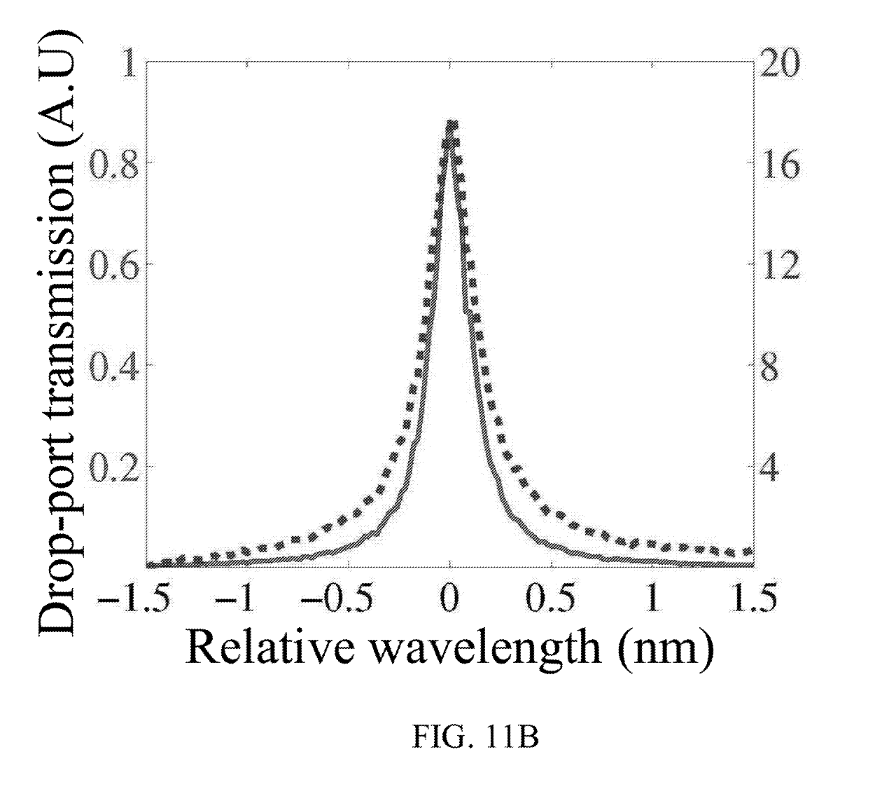

The measured Iₕₑₐₜₑᵣ versus Vₕₑₐₜₑᵣ for the MRR filter is shown in FIG. 11A using the experimental setup. The experimental setup included a radius of the MRR of 8 μm and with the IRPH formed over 63% of the MRR's circumference. The MRR is symmetrically coupled, with identical power coupling coefficients |k|²=0.047, corresponding to a gap of 255 nm, for the through- and drop-ports. The total waveguide loss is approximately 6.8 dB/cm. The above values for |k|² and waveguide loss were extracted from the measured MRR filter spectrum using a method similar to the one described in W. R. McKinnon, D. X. Xu, C. Storey, E. Post, A. Densmore, A. Delge, P. Waldron, J. H. Schmid, and S. Janz, “Extracting coupling and loss coefficients from a ring resonator,” Opt. Express 17, 18971-18982 (2009).

The power supplied to the IRPH shifts the resonance wavelength of the MRR at a rate of 0.25 nm/mW. FIG. 11B shows the measured drop-port optical transmission (for the solid line) and I_{PD} as a function of the wavelength of the optical input (for the dotted line) relative to 1551.52 nm. For this measurement, Vₕₑₐₜₑᵣ=1 V, and I_{PD} was determined by subtracting Iₕₑₐₜₑᵣ from the total measured current. In this example, the drop-port transmission is normalized to 87 μW, which was the estimated optical power in the bus waveguide at the input of the MRR filter.

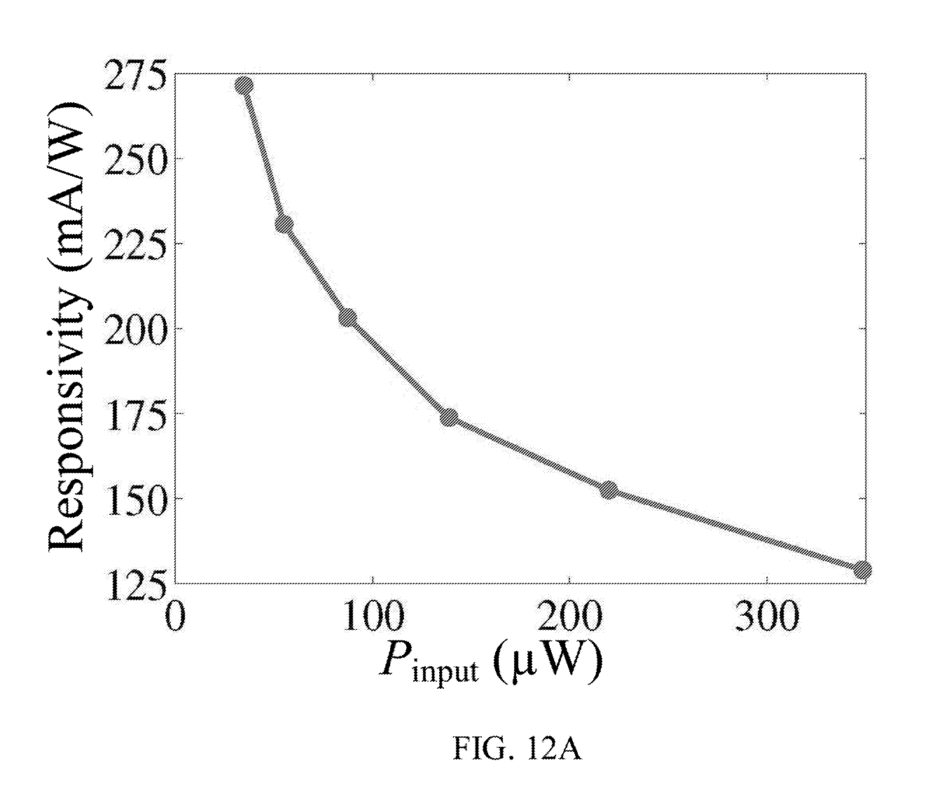

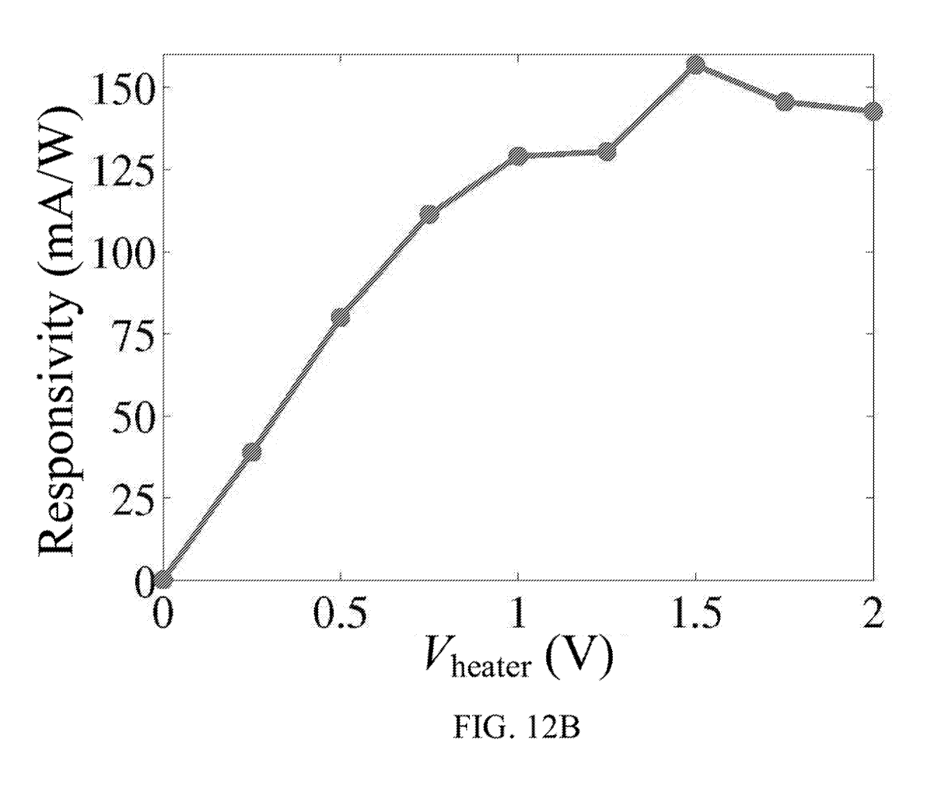

The responsivity of the IRPH at the MRR's resonance wavelength, λ₀, is defined as I_{PD}(λ₀)/Pᵢₙₚᵤₜ. The measured responsivities of the IRPH, measured at the resonance wavelength of the MRR as a function of Pᵢₙₚᵤₜ, where Vₕₑₐₜₑᵣ=1 V, and Vₕₑₐₜₑᵣ, where Pᵢₙₚᵤₜ=348 μW, are shown in FIGS. 12A and 12B, respectively. Pᵢₙₚᵤₜ is the optical power in the bus waveguide at the input of the MRR filter, which was estimated using the measured off-resonance through-port transmission. The measurements show that the responsivity decreases with increasing Pᵢₙₚᵤₜ. The responsivity increases as Vₕₑₐₜₑᵣ is increased. This increase is due to the increased strength of the electric field caused by the application of Vₕₑₐₜₑᵣ. Hence, the carrier transit times across the waveguide become smaller than the carrier lifetimes, increasing the responsivity of the device, wherein carrier lifetime denotes the average time it takes for carriers (i.e., the electrons and the holes in the semiconductor material) to recombine. The high responsivities of these devices are partly due to the high intensity build-up inside the MRRs, which was calculated to be about 17.3×Pᵢₙₚᵤₜ. The intensity build-up factor of an MRR is proportional to the MRR's finesse parameter, which is defined as the free spectral range/linewidth of the resonator. Accordingly, the implementations of the embodiments of the MRRs discussed herein have been designed to have a maximized finesse. The typical responsivities measured for the tested devices were about an order of magnitude larger than those reported for doped silicon waveguide photodetectors with p−n or p++-i-p++ doping. The responsivities measured for the implementation discussed above show an improvement upon those of the known art, either by having better responsivities, or comparable responsivities without the additional cost and complexity of defect implantation or the higher operational costs associated with a requirement of high reverse bias voltages.

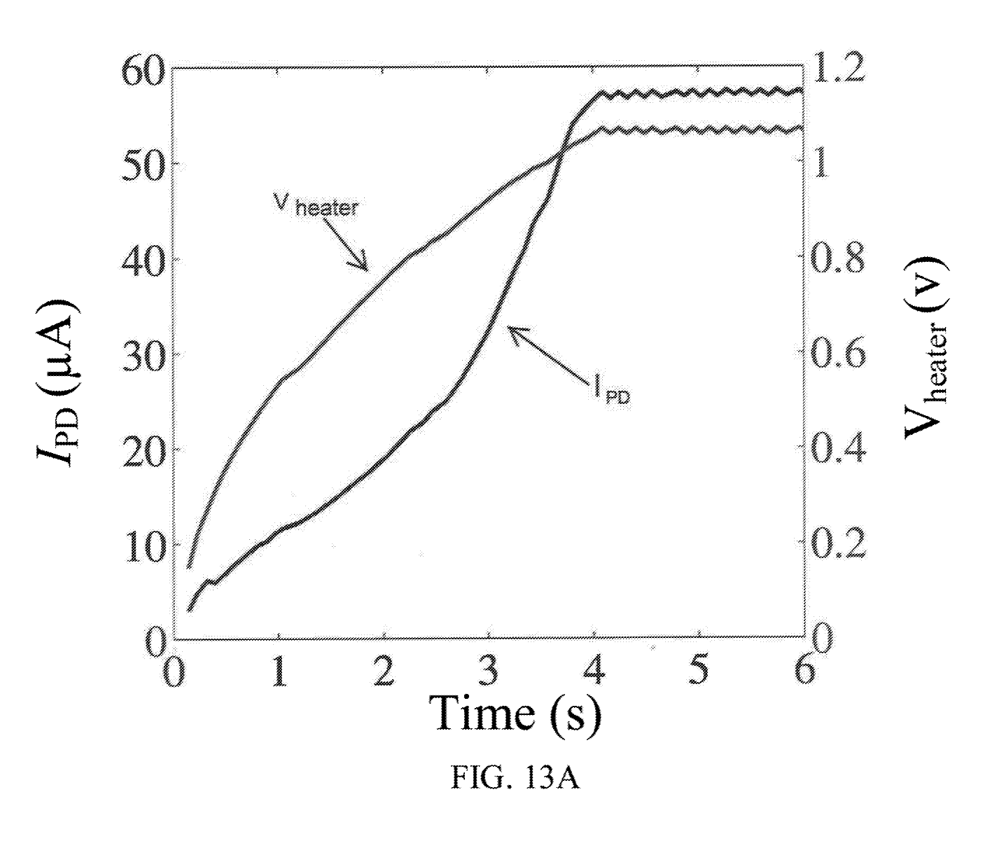

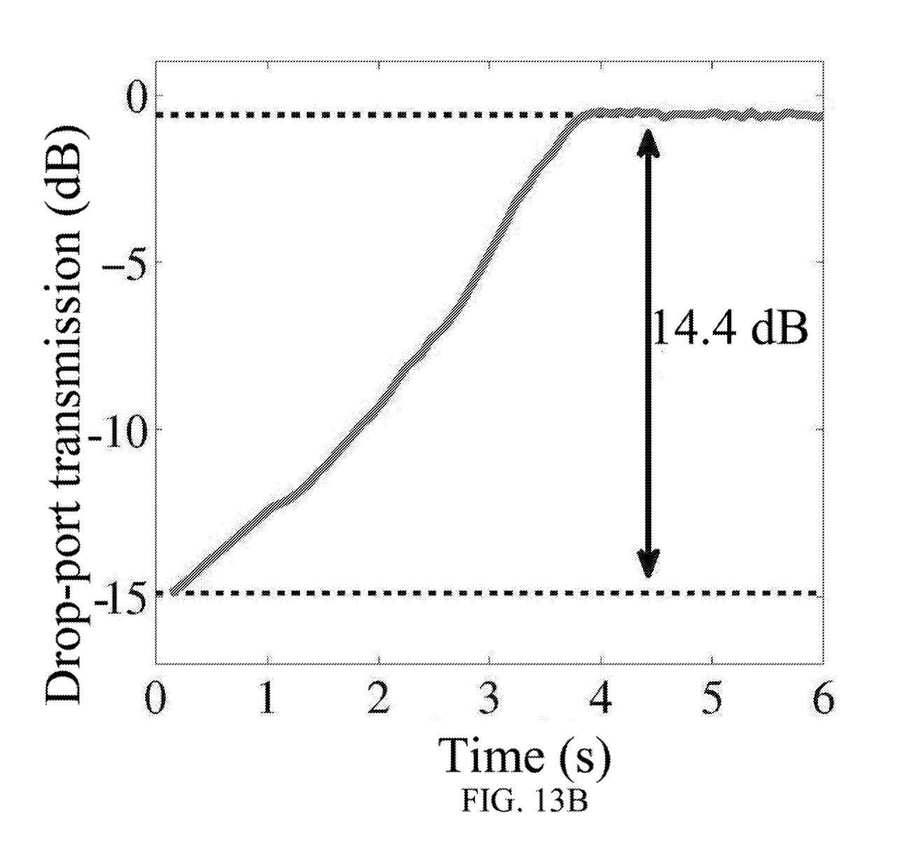

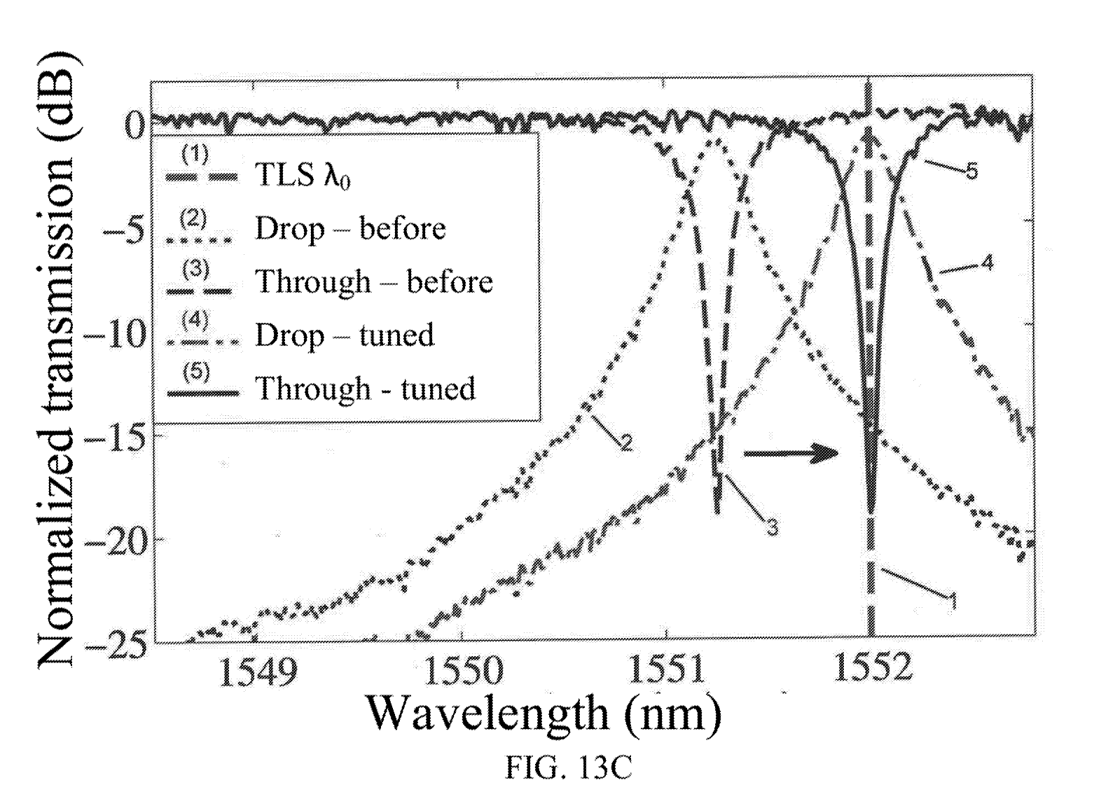

The photocurrent (I_{PD}), heater voltage (Vₕₑₐₜₑᵣ), and the measured drop-port optical power during the progression of the control algorithm are shown in FIGS. 13A and 13B. FIG. 13A illustrates the I_{PD} and Vₕₑₐₜₑᵣ values measured as functions of time. The slow response time observed is due to the use of the same General Purpose Interface Bus interface to communicate with all the instruments and the high integration time of the off-chip optical power monitor, which was used to measure the drop-port output power in FIG. 13B. FIG. 13B illustrates the normalized drop-port transmission measured as a function of time during the progression of the control algorithm discussed above with reference to FIG. 4. FIG. 13C shows the normalized through and drop-port transmission spectra of the MRR filter before and after the control algorithm was applied, wherein the output wavelength of the TLS was 1552 nm. The recorded wavelength spectra in FIG. 13C show that the drop-port power is maximized at the TLS output wavelength (1552 nm) after applying the control algorithm.

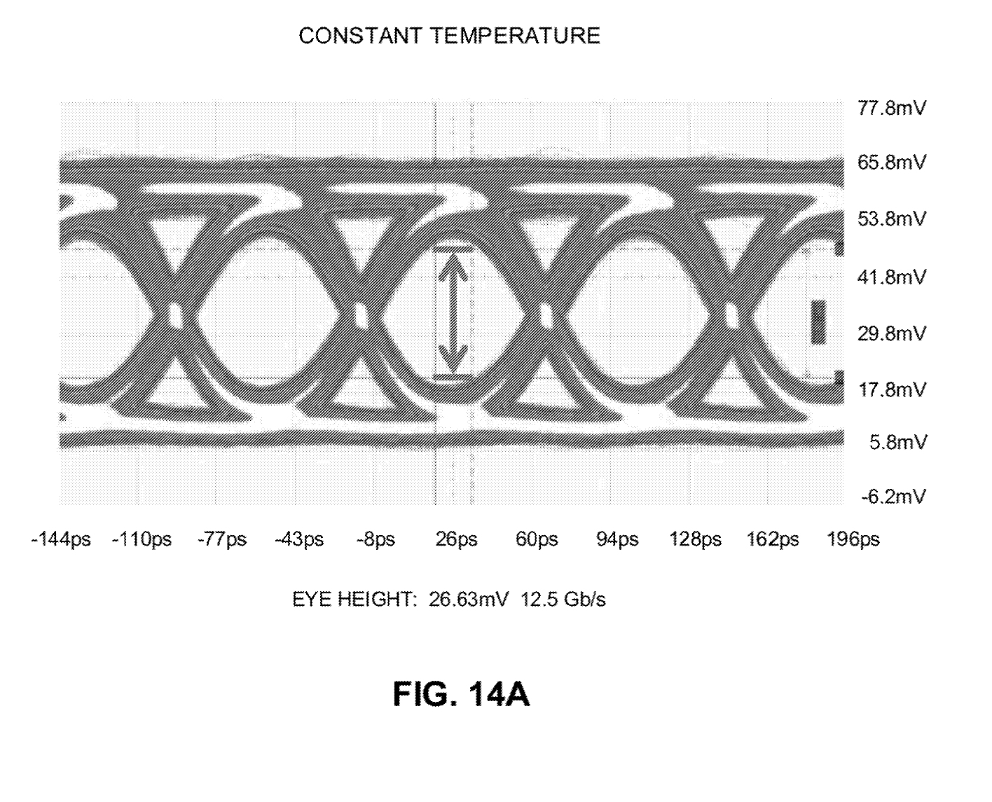

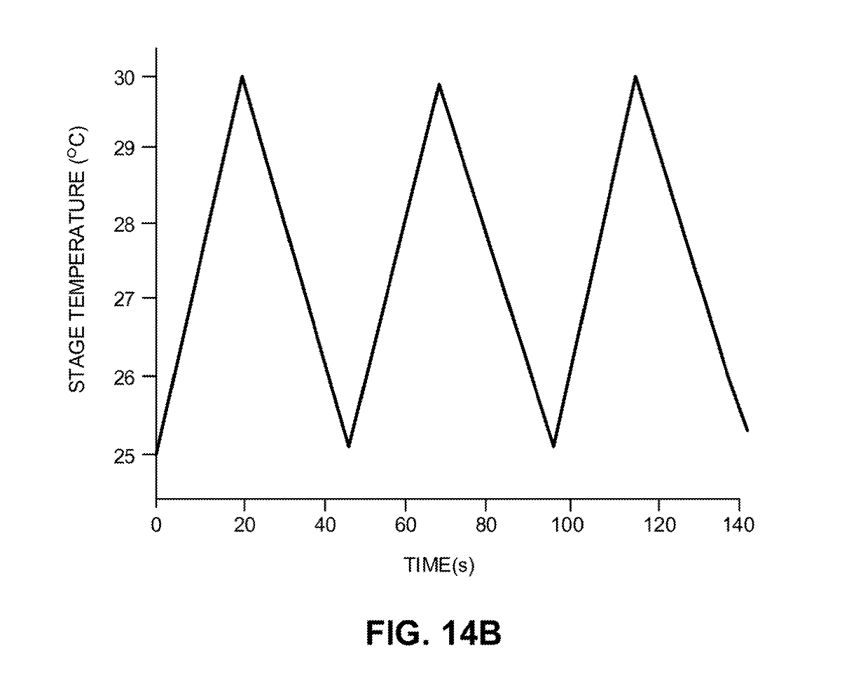

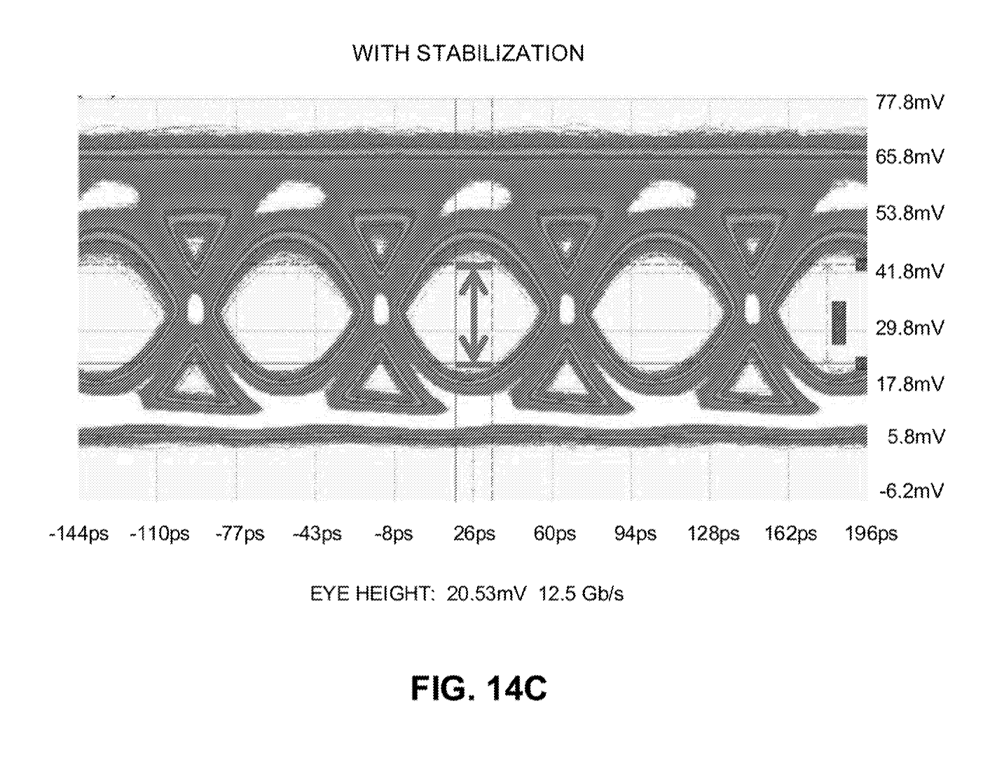

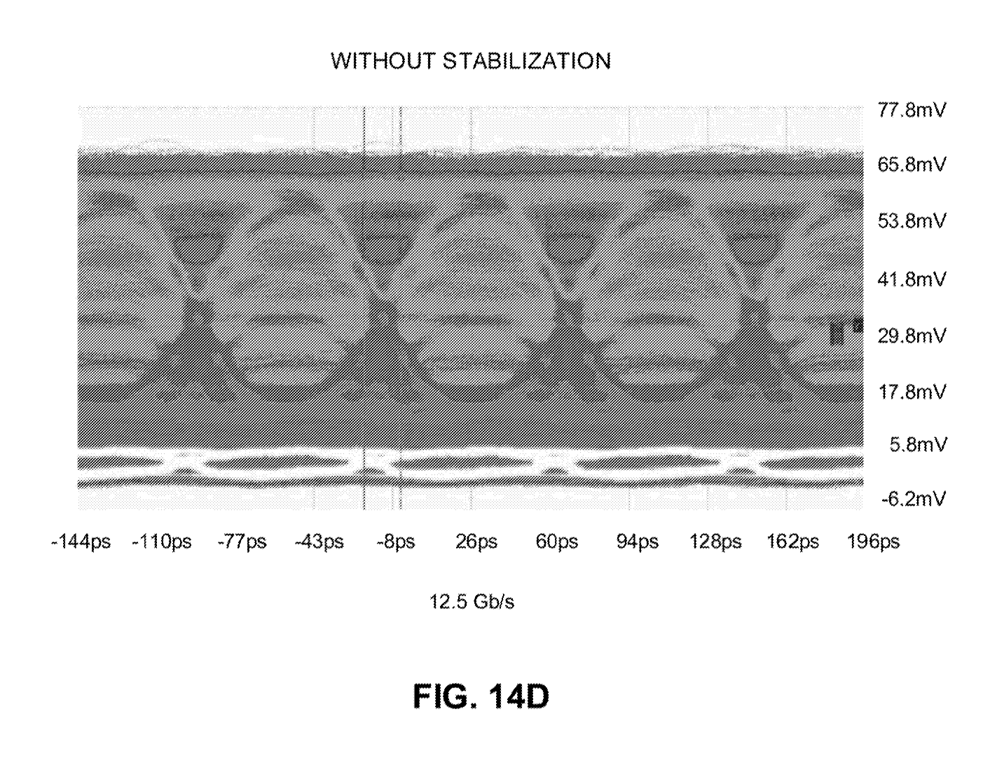

FIG. 14A shows the output eye diagram when the stage temperature was maintained at a constant level. For this measurement, the resonance wavelength of the MRR was manually aligned to the TLS wavelength and the control algorithm was not used. The minimum recorded eye height was 26.63 mV. When the control algorithm was turned on and the stage temperature was kept constant, the change in eye height was negligible. The applied stage temperature variation is shown in FIG. 14B. The temperature of the stage was changed from 25° C. to 30.2° C. and the rate of temperature change was approximately 0.28° C./s. This corresponded to a resonance wavelength shift of approximately 0.4 nm at a rate of about 20 pm/s. FIG. 14C shows the eye diagram with automated wavelength stabilization while the stage temperature was varied as shown in FIG. 14B. The eye diagram remained open for the duration of the measurement. The minimum recorded eye height was 20.53 mV, which was approximately a 23% reduction compared to the eye height recorded at a constant temperature. As shown in FIG. 14D, the eye diagram is completely closed for certain temperatures when the wavelength stabilization was not used. For each measurement, more than 1.7×10¹² bits were transmitted.

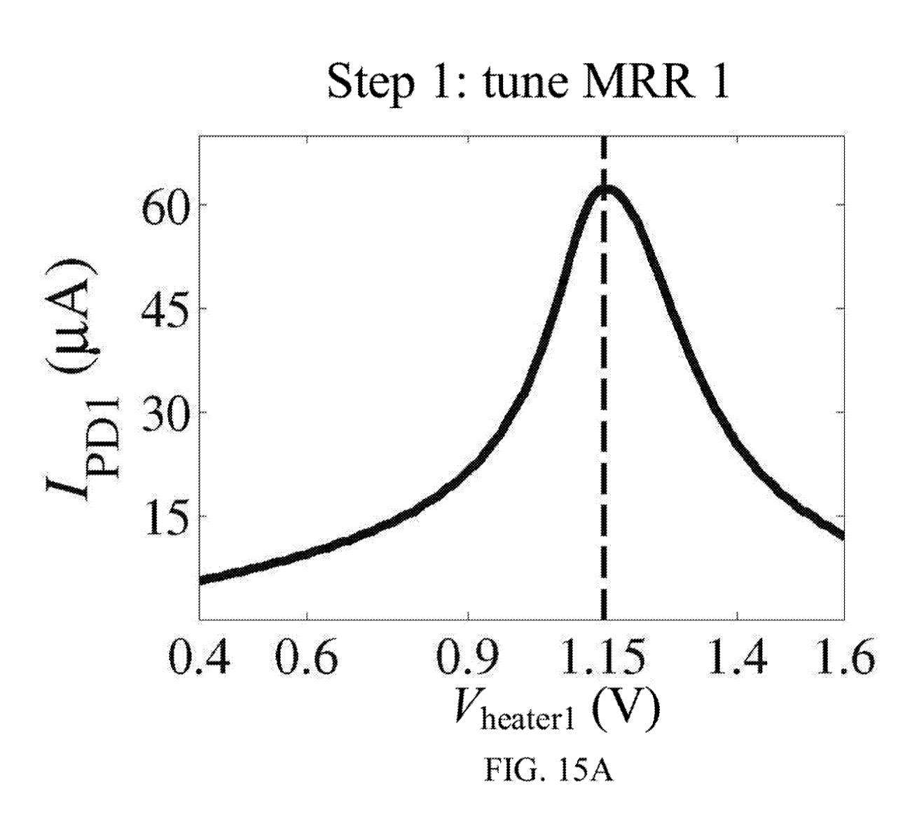

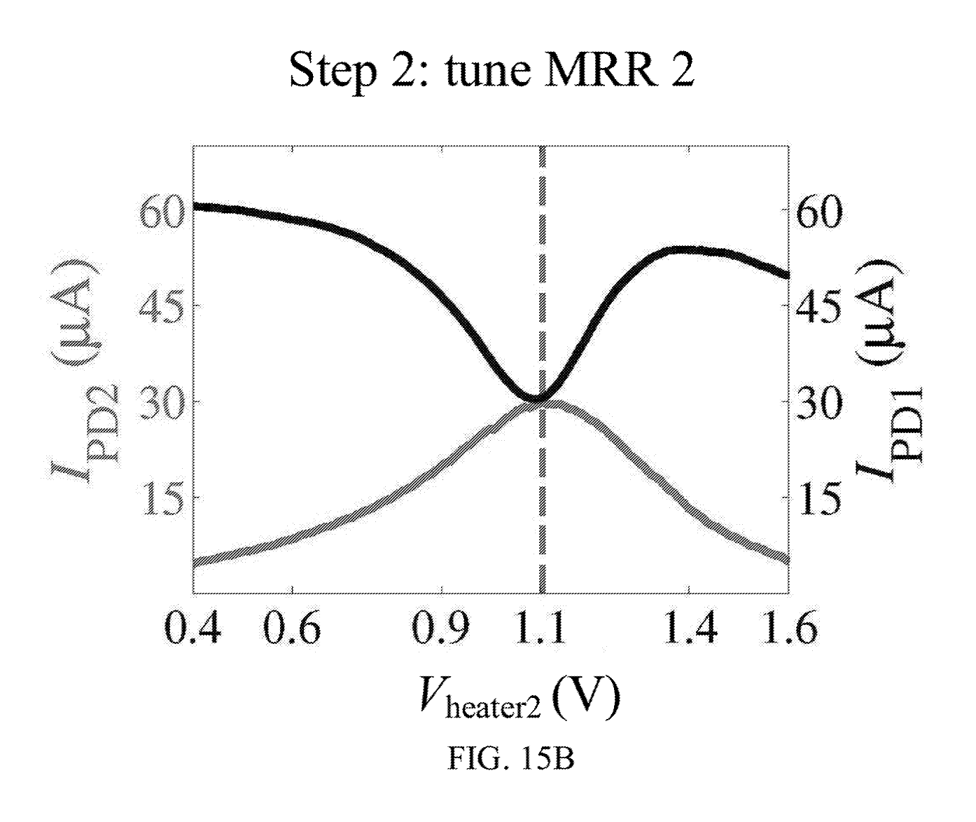

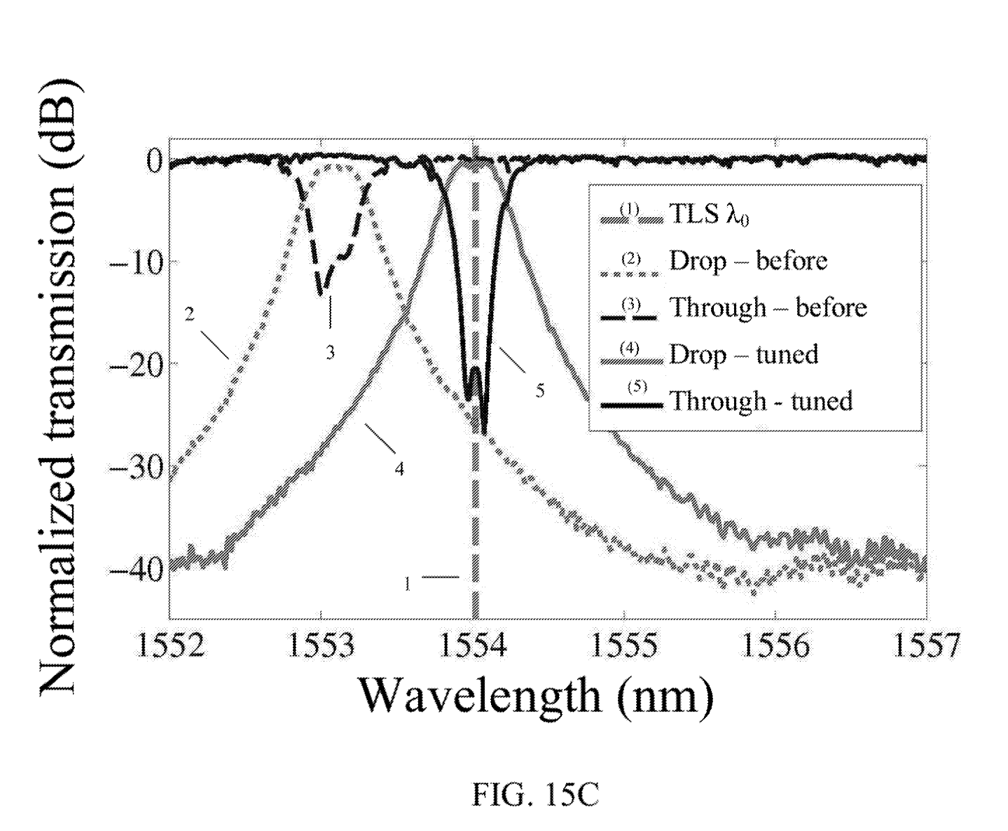

In some embodiments, initial tuning of the devices can be used in conjunction with, the control algorithms described above. The N^{th} order tuning method described above (with reference to FIGS. 9A-F) was used to tune an experimental set-up for a 2^{nd} order filter (similar to that illustrated in FIG. 5) to an initial wavelength, λ₀. In the experimental arrangement of 2^{nd} order filter, the bus-to-MRR and MRR-to-MRR gaps were designed to be |κ|²=0.0945, and 0.0024, respectively. The results of tuning MRR1 are shown in FIG. 15A, which shows the measured I_{PD1} as Vₕₑₐₜₑᵣ₁ was swept. After MRR1 was tuned, Vₕₑₐₜₑᵣ₁ was set to the value corresponding to the maximum I_{PD1}, which aligned the resonant wavelength of MRR1 to λ₀. The results of tuning MRR2 are shown in FIG. 15B, which shows I_{PD1} and I_{PD2} (the bottom curve and the left scale) as Vₕₑₐₜₑᵣ₂ was swept. Vₕₑₐₜₑᵣ₂ was set to the value corresponding to the maximum I_{PD2} in order to align the resonance of MRR2 to λ₀, which completed the tuning process. The through- and drop-port spectra before and after tuning the filter to a wavelength of 1554 nm are shown in FIG. 15C. After tuning, the filter's spectral response was improved, having a drop-port insertion loss less than 0.4 dB and a through-port extinction ratio more than 20 dB.

In addition to the initial tuning of such a second order setup, wavelength stabilization results for an experimental usage of a control algorithm, similar to that discussed with reference to FIG. 6, were obtained, in which I_{PD2} was maximized. Maximizing I_{PD2} maximizes the optical intensity in MRR2, which maximizes the drop-port transmission because the drop-port transmission is |κ|² times the intensity in the MRR. In this case, the round-trip phases of MRR1 and MRR2 (φ₁ and φ₂) were written in terms of

$${φ}_{diff} = \frac{( {φ}_{1} - {φ}_{2 )}}{2} and {φ}_{avg} = \frac{( {φ}_{1} + {φ}_{2 )}}{2} .$$

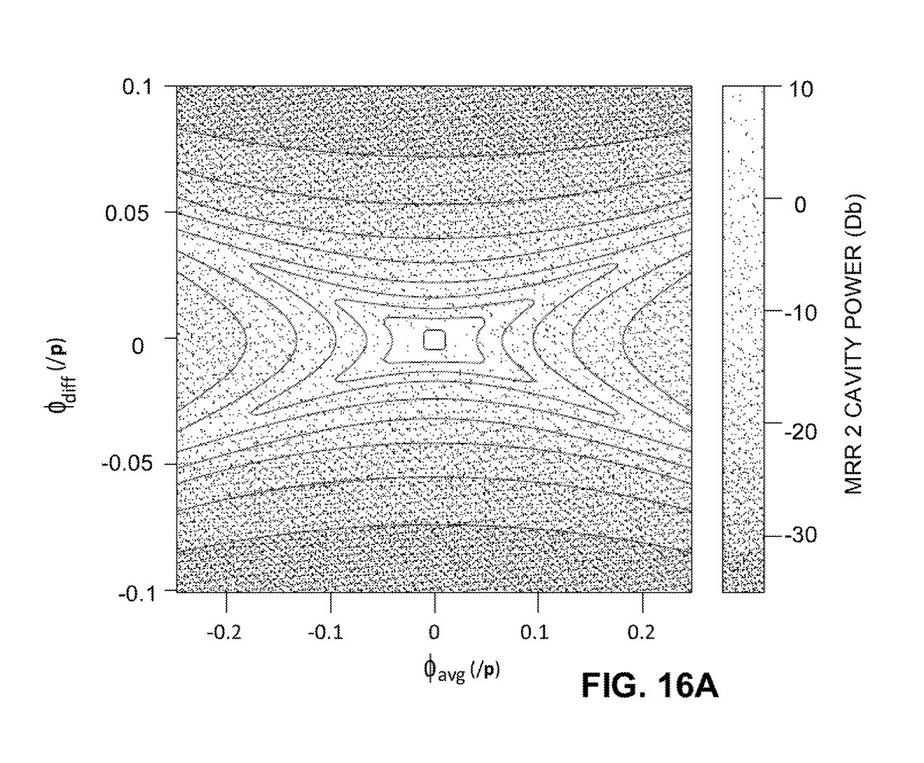

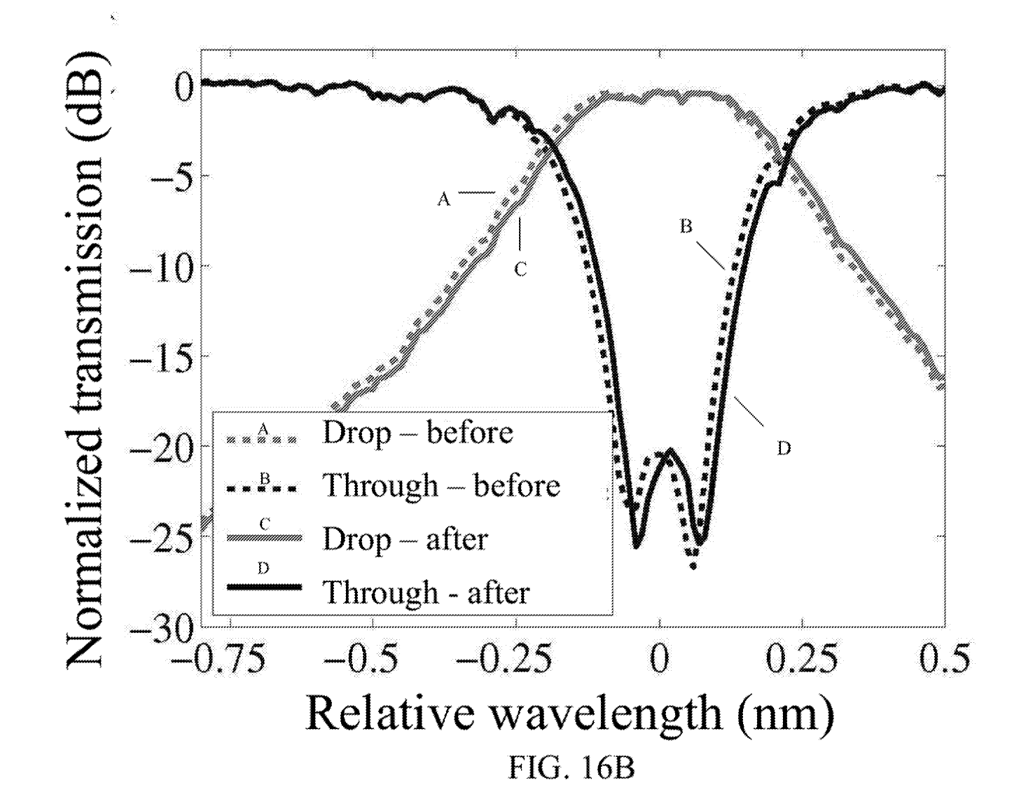

FIG. 16A shows the calculated optical cavity intensity as a function of φ_{diff} and φ_{avg}. The light intensity in MRR2 has a single maximum point corresponding to the case where φ₁=φ₂=2mπ, which yields the tuned filter response as described above. The MRRs were tuned in terms of φ_{diff} and φ_{avg} because the largest slopes of the MRR2's optical cavity intensity occur along the φ_{diff} and φ_{avg} axes, thereby yielding the highest sensitivity to changes in I_{PD2} when a maximum search algorithm is used.

FIG. 16B shows the measured spectra before and after applying the control algorithm illustrated in FIG. 6 to an experimental device similar to that shown in FIG. 5. Before applying the control algorithm, the filter was tuned to a wavelength of 1554 nm using the wavelength tuning algorithm, and curves A and B show the drop and through port measurements respectively. The control algorithm was applied to the MRR filter while keeping the chip temperature constant and curves C and D show the drop and through port measurements respectively after the control algorithm is applied.

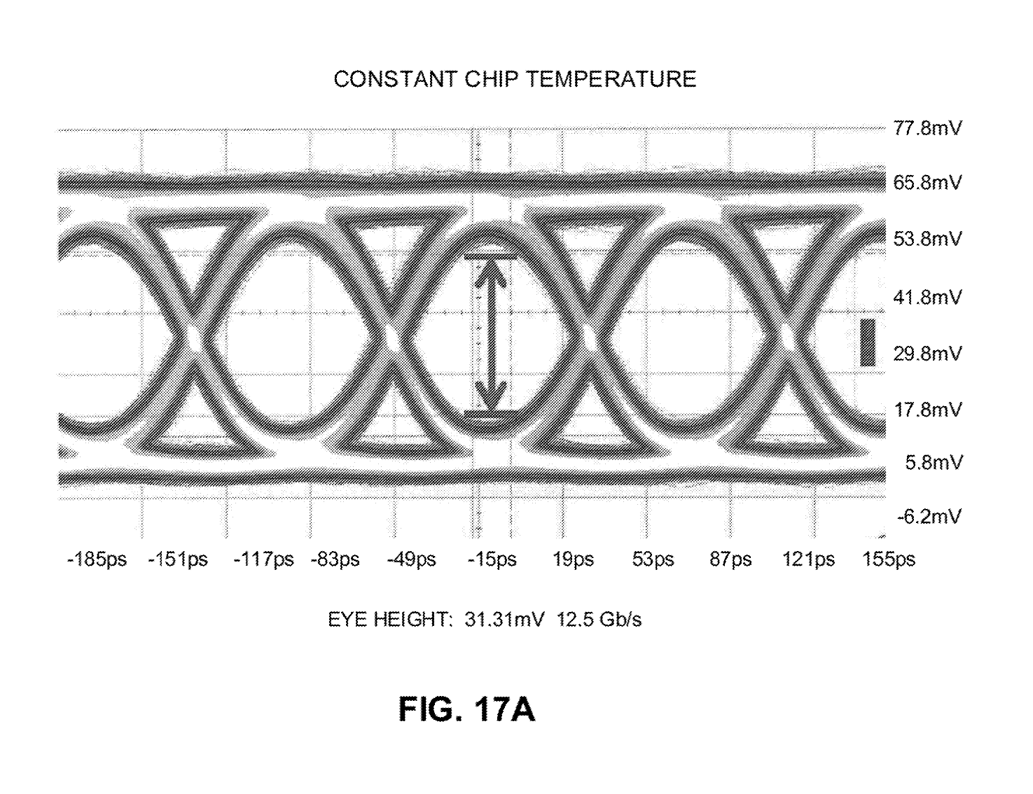

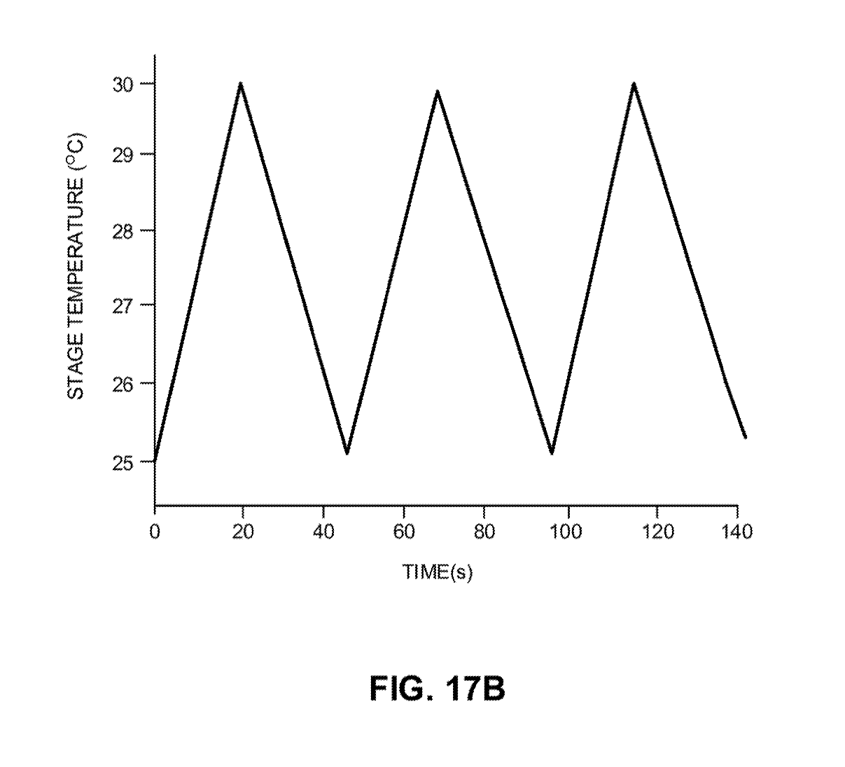

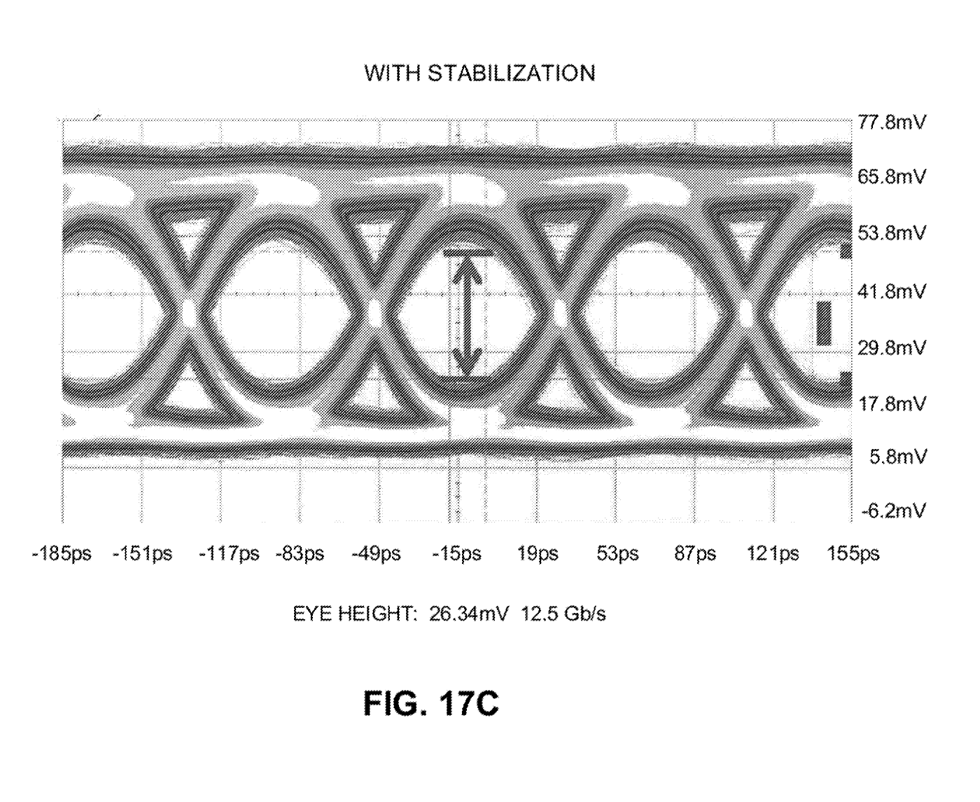

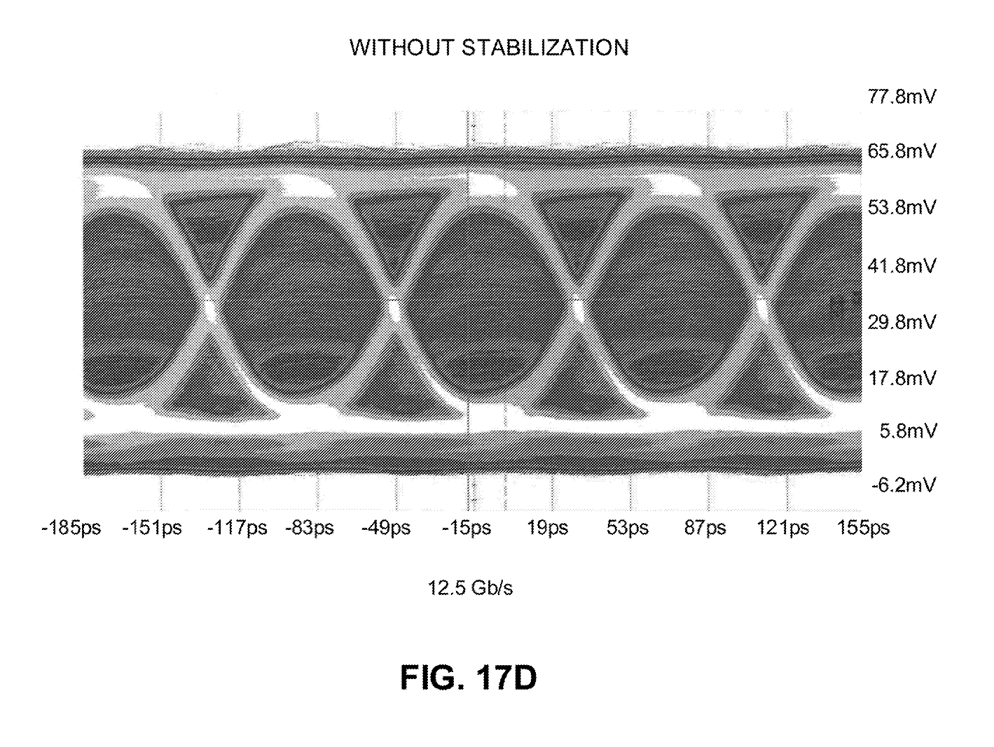

Eye diagram measurements for the 2^{nd} order MRR experimental setup were also obtained. FIG. 17A shows the output eye diagram when the chip temperature was maintained at a constant value and the control algorithm was turned off. The chip temperature was varied according to the profile shown in FIG. 17B in order to test the wavelength stabilization algorithm. The chip temperature ranged from 25.0° C. to 30.2° C. and the rate of temperature change was approximately 0.28° C./s. As shown in FIG. 17C, with the control algorithm on, the eye diagram was open. More than 1.7×10¹² bits were transmitted. The minimum recorded eye height was 31.31 mV when the chip temperature was constant and the control algorithm was turned off. When the control algorithm was turned on and the chip temperature was kept constant, the reduction in eye height was less than 1 mV. When the chip temperature was varied and the control algorithm was on, the minimum recorded eye height was 26.34 mV. FIG. 17D shows that the eye diagram is completely closed when the control algorithm is off.

Embodiments discussed herein have several advantages. For example, they do not require any dedicated ion implantation steps to introduce defects, or germanium deposition. Further, embodiments do not require the use of dedicated photodetectors which increases the footprint of the devices. Although a photodetector was employed in the experimental setup illustrated in FIG. 10, as previously stated it was used for the purposes of measuring output from the device for evaluation of the device in an experimental context. The photodetector was not needed to control or tune the device itself, as it would have been in prior art devices. Also, the above described embodiments do not require power taps of the output signal, as required by some prior art devices. Furthermore, the IRPHs can be used to measure the optical cavity intensity in the MRRs and, hence, this approach can be readily extended to devices/systems which require simultaneous wavelength tuning or stabilization of multiple MRRs.

It is noted that the IRPHs discussed above use n-doped waveguides, which have about 6 dB/cm of additional losses compared to undoped waveguides. However, the MRR-based devices can still be designed to have negligible drop-port losses by controlling the bus-to-MRR and MRR-to-MRR coupling coefficients appropriately. For example, the drop-port losses for first-order and second-order MRR devices presented herein were less than 1 dB and 0.5 dB respectively. The doped photodetectors of some prior art devices which use p-n junctions operate in reverse bias and have low dark currents. The experimental IRPHs discussed herein have dark currents in the order of mAs, however they are simultaneously used for the thermal tuning of the MRRs so they do not consume additional power. Furthermore, the responsivities of the IRPHs are large enough so that even at low voltages (e.g., 0.3 V) they can be used for wavelength tuning and stabilization. The measurements showed that the photocurrent of the IRPH depends on input power, bias voltage and chip temperature. However, these effects have a negligible impact on the performance of wavelength tuning and stabilization using a control algorithm which only requires maximizing I_{PD}.

Features of embodiments include the following. The responsivities measured for the IRPHs were in the order of 100 mA/W, which was consistent for multiple MRR devices on various fabrication runs. The IRPHs measure the light intensity in the MRRs; therefore, they can be used for automated tuning of devices by aligning the resonance wavelength of multiple MRRs. An Nth-order series-coupled MRR filter can be automatically tuned using IRPHs by sequentially aligning the resonance wavelength of each successive MRR to the laser-wavelength. The methods demonstrated in this disclosure for wavelength tuning and stabilization of MRR-based filters did not require any dedicated ion implantation steps to introduce defects, or require germanium deposition, PDs, or optical power tap-outs.

Embodiments discussed herein have several benefits compared to prior art devices which simply use waveguides and a heater. For example, the devices created from embodiments discussed herein may be simpler to fabricate, with no additional required manufacturing process steps. In particular, such devices do not need the traditional germanium photodetector or germanium photoconductor which can require 3 or more mask steps and a complicated germanium growth step. Further, no extra photodiodes are required, as the doped heaters are used for both sensing and thermal tuning which saves space and reduces complexity and cost. Further, the number of electrical pads required is reduced. The sensing and control operations (for example as carried out by the source measure unit) use the same two electrical pads for both the sensing and control signals. Further, the automated tuning algorithms can control systems based on single or multiple microring devices.

According to an embodiment, a microring is tuned by passing current through a heater, which heats the waveguide, causing a change in refractive index, and thus changing the resonance wavelength of the microring. These photoconductive heaters are integrated into microring resonator filters which are used to automatically tune and stabilize the filter's resonance wavelength to the input laser wavelength.

In an embodiment, the tunable optical element is formed from an input metal contact, a heavily doped semiconductor, a lightly doped semiconductor which is also the optical waveguide region, a further heavily doped semiconductor, and an output metal contact. All three doped regions can be n-type or all three can be p-type semiconductors, with n-type being used in the experimental demonstrations presented here.

In an embodiment, the heater also acts as a photodetector, using intra-band absorption states of the semiconductor waveguide material. The monitor circuit detects the change in current-voltage (I-V) output of the heater. A photodetector is a device that creates electrical charges in response to incident light. The microring comprises materials selected with a bandgap at a shorter wavelength than the operating wavelength. It is not conventionally expected that the microring acts as a photodetector. However, by lightly doping the optical waveguide semiconductor region, the semiconductor has electron states that are within the bandgap. Thus, the light in the waveguide weakly interacts with the dopants to create a small electrical space charge in the waveguide. This space charge changes the resistance of the semiconductor, and thus changes the current-voltage characteristics (I-V) of the heater, which can be sensed by the monitor circuit (also called the source measure unit). Thus, the monitor circuit measures the optical power in the waveguide. As the heater is driven (controlled) by the source measure unit, the source measure unit detects the change in I-V to tune the heater (and thus the MRR) accordingly. When the microring is on resonance, the optical power travelling around the microring is much larger than the power in the transport waveguides, due to the resonance in the microring. Thus, the circulating optical power can be detected even using a very weak photodetector. Experiments with n-doped resistive heaters in silicon waveguides have photoconductive effects with high responsivities on the order of 0.1 mA current per mW of light, which translates into a significant change in the I-V curve.

Accordingly, embodiments utilize three features of the lightly doped silicon materials uses in such an MRR. First, the lightly doped silicon acts as the core of an optical waveguide. Second, the lightly doped silicon material acts a resistive heater. Accordingly, passing current through it heats the waveguide, changing the waveguide's refractive index. This changes the resonance when the waveguide is in a microring resonator. Thirdly, the lightly doped silicon has a photo-conductive effect as the resistance changes when stimulated with light, which changes the I-V output from the device. Accordingly, when light is resonating in the ring, the I-V curve scales upward. This can be used to finely tune the wavelength properties of the device as a filter. When the wavelength of the input light is resonant to the ring, the current peaks and that wavelength is directed to the drop port. When the wavelength of the input light is not resonant to the ring, the output current is almost the same as if there is no incident light and the wavelength is directed to the through port. As an alternative embodiment, the voltage is varied by the control circuit, and locked (through the feedback) to the voltage when the current peaks, which occurs when light is resonant to the ring.

According to the example embodiments discussed herein, the IRPHs can be formed by using n-type doping in a waveguide section. However, other embodiments could use P-type doping to form the heater sections.

Embodiments may be constructed using semiconductor materials such as silicon, gallium arsenide, indium phosphide and graphene. The mid-band-gap energy levels may be states of the bulk semiconductor or surface states. For example, a germanium or silicon-germanium p-i-n photodetector may be used. However, challenges to overcome in implementing these elements include the additional complexity of fabrication, possible additional space requirements and possible increased loss in optical power.

Embodiments comprise materials in or close to the waveguide, where the bandgap of said materials occurs at a longer wavelength than the operating wavelength. As absorption occurs at intra-band states that arise from doping, materials should be chosen such that operating wavelength is below the bandgap (to avoid background absorption and accordingly optical loss). In some embodiments, the electrical responsiveness to light of the semiconductor materials is due to absorption of light by defects within the semiconductor material induced by the doping or by defect states of the semiconductor material induced by imperfections of the crystal structure at a surface of the semiconductor material.

Tunable filters incorporating the aspects discussed herein can have many applications. Such tunable filters can be used to add/drop wavelengths in a reconfigurable optical add/drop multiplexer (ROADM). Such tunable filters can be used in wavelength-locking circuits in a tunable transmitter. They can also be used to create a spectrometer for use in an optical network monitor, for scanning and measuring the signal strength on different wavelengths. They could also be used for spectroscopy in other applications.

Through the descriptions of the preceding embodiments, the present invention may be implemented by using hardware only or by using software and a universal hardware platform. Based on such understandings, aspects may be embodied in the form of a software product executed by a processor of the source measure unit (which can also be called a Drive/Sense circuit). The software product may be stored in a non-volatile or non-transitory storage medium, the software product including a number of instructions that enable a processor to execute the methods provided in the embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A tunable optical element comprising:
a semiconductor material arranged to form a microring resonator (MRR); and
an in-resonator photoconductive heater (IRPH) comprising at least a portion of the semiconductor material doped at a first doping level such that the IRPH both heats the MRR in response to an electrical input applied to the IRPH and is electrically responsive to light within the MRR, producing a photocurrent responsive to the light in the MRR.

2. The tunable optical element as claimed in claim 1 further comprising electrical contacts for providing the electrical input to the IRPH to control the degree of heating, and for supplying the photocurrent to a feedback circuit such that the photocurrent produced by the IRPH can be used by the feedback circuit to control the degree of heating.

3. The tunable optical element as claimed in claim 2 wherein the semiconductor material further includes inner and outer portions doped at a second doping level, the inner and outer portions configured to provide low-resistance electrical contacts to the IRPH.

4. The tunable optical element as claimed in claim 3 wherein:
the semiconductor material is silicon shaped as a waveguide;
the IRPH comprises an n-doped middle portion of the semiconductor material; and
wherein the second doping level comprises n++ doping.

5. The tunable optical element as claimed in claim 1 wherein the photocurrent produced by the IRPH is dependent on intensity of the light in the MRR.

6. The tunable optical element as claimed in claim 5 wherein the electrical input supplied via the electrical contacts heats the IRPH to adjust such that the MRR resonates at a desired wavelength.

7. The tunable optical element as claimed in claim 6 wherein the MRR comprises a circular ring, and wherein the tunable optical element further comprises an input waveguide for supplying light at a plurality of wavelengths into the MRR, and a drop waveguide for outputting the desired wavelength, which resonates within the MRR.

8. The tunable optical element as claimed in claim 6 wherein the electrical responsiveness to light is due to absorption of light by defects within the semiconductor material induced by doping.

9. The tunable optical element as claimed in claim 6 further comprising a plurality of MRRs, together with corresponding IRPHs, communicatively coupled together.

10. The tunable optical element as claimed in claim 3 wherein the second doping level is higher than the first doping level.

11. The tunable optical element as claimed in claim 2 wherein the electrical contacts comprise same contacts for providing the electrical input to the IRPH; and for supplying the photocurrent to the feedback circuit such that the photocurrent produced by the IRPH can be used by the feedback circuit to control the degree of heating.

12. A tunable optical element comprising:
a microring resonator (MRR) formed from a semiconductor material;
an integrated in-resonator photoconductive heater (IRPH) formed by doping the semiconductor material and integrated with said MRR, said IRPH acting as both a resistive heater and a photoconductive material;
electrical contacts; and
a feedback circuit connected through the electrical contacts to a more heavily doped region of the semiconductor material to both control the heating of the IRPH and to measure a photoconductive response of said IRPH in order to tune said MRR.

13. The tunable optical element as claimed in claim 12 wherein the semiconductor material is silicon shaped as a ring waveguide and comprising an n doped ring region to form the IRPH, and a n++ doped contact region to reduce the electrical resistance of the n++ doped contact region to facilitate flow of electrical current between the ring region and the electrical contacts.

14. The tunable optical element as claimed in claim 13 wherein the electrical contacts comprise dual-purpose contacts to provide the electrical input to the IRPH to control a degree of heating, and to supply photocurrent produced in the ring region to the feedback circuit such that the photocurrent can be used by the feedback circuit to control the degree of heating of the ring region.

15. The tunable optical element tunable optical element as claimed in claim 14 wherein the photocurrent produced in the ring region is dependent on a degree to which the ring waveguide resonates with a wavelength of light in the ring waveguide.

16. The tunable optical element as claimed in claim 14 wherein the feedback circuit tunes the ring waveguide by adjusting the electrical current supplied, such that ring waveguide continues to resonate at a desired wavelength.

17. The tunable optical element as claimed in claim 16 wherein the ring waveguide is circular in shape.

18. The tunable optical element as claimed in claim 16 further comprising a plurality of such MRRs and associated IRPHs communicatively coupled together.

19. The tunable optical element as claimed in claim 18 wherein the feedback circuit tunes each of the plurality of MRRs in sequence in order to center the filter response at the desired wavelength.

20. A method for using a doped semiconductor waveguide arranged in a loop such that light can circulate around the loop, the method comprising:
using a pair of electrical contacts to connect the doped semiconductor waveguide to a feedback circuit;
applying an electrical input via the pair of contacts to heat the doped semiconductor waveguide; and
using the same pair of electrical contacts to measure a photoconductive response of the doped semiconductor waveguide to control the degree of heating.
